(19) United States
(12) Patent Application Publication
(10) Pub. No.: US 2013/0309591 A1
(43) Pub. Date: Nov. 21, 2013

(54) NANOPOROUS ENERGY CHIPS AND RELATED DEVICES AND METHODS

(71) Applicant: Nanotune Technologies Corp., Mountain View, CA (US)

(72) Inventors: Kuan-Tsae HUANG, Mountain View, CA (US); Shiho WANG, Mountain View, CA (US); Cheuk Wun WONG, Mountain View, CA (US); Jaspal SINGH, San Jose, CA (US); Yudi YUDI, Alameda, CA (US)

(73) Assignee: NANOTUNE TECHNOLOGIES CORP., Mountain View, CA (US)

(21) Appl. No.: 13/870,913

(22) Filed: Apr. 25, 2013

Related U.S. Application Data
(60) Provisional application No. 61/638,420, filed on Apr. 25, 2012.

(51) Int. Cl. H01M 4/66; H01G 4/01; H01G 11/24; H01M 4/86

(52) U.S. Cl. CPC H01M 4/663; H01M 4/8605; H01G 4/01; H01G 11/24; Y10S 977/948; B82Y 99/00
USPC 429/452; 429/233; 429/245; 429/532; 429/530; 429/50; 429/156; 429/158; 264/104; 361/303; 361/502; 977/948

(57) ABSTRACT

High surface area energy chips that can be used to make high surface area electrodes and methods for making high surface area energy chips are described. The energy chips comprise a monolithic conductive material comprising an open network of pores having an average pore diameter between about 0.3 nm and 30 nm. The conductive material forms a thin chip having a thickness of about 300 microns or less, and the thickness across different portions of the chip varies by less than 10% of the thickness. The high surface area energy chips may be used as electrodes in a variety of energy storage devices and systems such as capacitors, electric double layer capacitors, batteries, and fuel cells.

### CROSS-REFERENCE TO RELATED APPLICATIONS

This application claims the benefit of U.S. Provisional Application No. 61/638,420, filed Apr. 25, 2012, which is hereby incorporated by reference, in its entirety.

### FIELD

Described herein are energy chips that can be used to make high surface area electrodes for use in electrical energy storage devices, e.g., as electrodes in capacitors such as electric double-layer capacitors, or in fuel cells, or for battery electrodes.

### BACKGROUND

A capacitor consists of two spaced apart electrodes with a potential applied between the electrodes. Capacitance (C) is a measure of charge (O) stored on those electrodes at a given applied potential (V): C=Q/V. A dielectric may be inserted in between the two electrodes. The energy (E) stored by a capacitor is given by (½)·CV², which can be approximated by C=∈₀∈₁A/d, where ∈₀ is vacuum permittivity, ∈₁ is dielectric constant of a medium between the electrodes, A is an effective cross-sectional area of the electrodes, and d is an effective spacing between the electrodes. Thus, to increase energy storage by a capacitor, a cross-sectional area of one or more electrodes can be increased, and/or a distance between electrodes can be decreased. Frequency-dependent equivalent series resistance (ESR) in a capacitor leads to internal heat losses. Thus, if ESR in a capacitor is reduced, power losses due to internal heat generation may be correspondingly reduced, leading to improved usable power (P) in that capacitor for a given applied voltage (V): P=V²/(4·ESR).

Ultracapacitors, also known as supercapacitors or electric double layer capacitors (EDLC) comprise a cell that, in turn, comprises two electrodes immersed in an electrolyte with a separator or membrane that is permeable to ions in the electrode placed between the electrodes in the electrolyte to divide the cell into two sections. An insulating separator or membrane that is permeable to electrolyte ions may be placed in a liquid electrolyte between the electrodes to prevent the cell from shorting. As a potential is applied between the electrodes, electrolyte ions can diffuse to the surface of the electrode. No electron transfer takes place at either electrode surface; instead electrostatic interactions between the charged electrode surface and the electrolyte ions in solution build up an electric double layer at each electrode. Electrical energy is stored in the electric double layers from charge separation between the electrolyte ions and the charged electrodes. Each electrode in an EDLC is a capacitor distinguishing EDLCs from typical capacitors as described above. The very small distance between these separated charges can lead to storage of very high charge densities when high surface area electrodes are used.

Batteries rely on electrochemical reactions at electrodes. Here again, energy storage in a battery, e.g., a lithium ion battery, may in some cases be increased by increasing a surface area of an active material at an electrode surface.

Thus, a need exists for improved high surface area electrodes for energy storage devices, energy storage devices utilizing such improved high surface area electrodes, and energy storage devices exhibiting reduced equivalent series resistance.

### SUMMARY

The invention provides nanoporous energy chips comprising a conductive material, wherein the conductive material is monolithic and comprises an open network of pores having an average pore diameter between about 0.3 nm and about 30 nm, and wherein the conductive material forms a thin chip having a thickness of about 300 microns or less. In some embodiments, the thickness across different portions of the chip varies by less than 10% of the thickness. In some embodiments, the thin chip is substantially flat. For example, the peak-to-reference flatness deviation across different portions of the chip is less than 10% of the thickness of the chip. In some embodiments, the peak-to-valley roughness of the chip surface may be less than 10% of the thickness of the chip.

In some applications, the conductive material may have an average pore size in a range from about 0.3 nm to about 30 nm, from 0.3 nm to about 25 nm, from about 0.3 nm to about 20 nm, from about 0.3 nm to about 15 nm, or from about 0.3 nm to about 10 nm. In some variations of the energy chips, the conductive material may comprise a pore size distribution where at least about 50% of the pores are within about 30% of an average pore size, within about 20% of an average pore size, or within about 10% of an average pore size. The conductive material may be selected to have a preselected average pore size and/or a pore size distribution. For example, for energy chips that are to be used in an energy storage device utilizing an electrolyte, an average pore size or pore size distribution in the conductive material may be selected to accommodate an ionic species contained in the electrolyte.

The conductive surface area of the energy chips may be selected based on the intended application of the energy chip. For example, some energy chips may have a conductive surface area of at least about 1000 m²/g, or even higher, e.g., at least about 1500 m²/g, at least about 2000 m²/g, at least about 2200 m²/g, at least about 2500 m²/g, at least about 3000 m²/g, at least about 4000 m²/g, or at least about 5000 m²/g.

The conductive material may comprise any suitable materials, e.g., graphite, graphite-like conductive carbon (carbide), graphene, a graphene-like material, carbon, activated carbon, conductive carbons derived from the polymerization and carbonization of carbon precursor materials, a metal (such as platinum, nickel, gold, palladium, molybdenum), a metal oxide (such as tin oxide, indium tin oxide, zinc oxide, zinc manganese dioxide, zinc manganese dioxide, oxy nickel hydroxide, lithium copper oxide, lithium manganese dioxide, lithium vanadium oxide, mercury oxide, molybdenum oxide, ruthenium oxide, tungsten oxide, manganese dioxide, silver oxide, nickel oxyhydroxide, aluminum doped zinc oxide, titanium oxide, vanadium pentoxide), sulfides (such as molybdenum sulfide, tungsten sulfide, iron sulfide, lithium iron disulfide), nitrides (such as tungsten nitride, molybdenum nitride), phosphates (such as lithium iron phosphate, lithium iron fluorine phosphate), other materials such as zinc carbon, zinc chloride, lithium ion, lithium manganese spinel, lithium nickel manganese cobalt, lithium air, 5% vanadium-doped lithium iron phosphate olivine, metal hydrides, silver zinc, nickel cadmium, nickel metal hydride, nickel zinc, or combinations thereof, and/or conductive polymers (such as poly(3-methylthiophene)), polyaniline, poly-fluorophenylthiophene, polypyrrole, poly[3-(4-difluorophenylthiophene)], poly[3-(4-aminophenyl) propionic acid], poly[3-(3,4-difluorophenylthiophene)], 3,4-poly(ethylenedioxythiophene, diaminoanthraquinone, polyacetylene). The conductive material may comprise any combination of these materials. Examples of carbon precursor materials include, but are not limited to, furfural, furfuryl alcohol (2-furylmethanol), polyfurfuryl alcohol, resorcinol formaldehyde, sucrose, glucose, melamine, and the like. As stated above, the energy chips may be used in an energy storage device such as a capacitor, an ultracapacitor, a fuel cell, or a battery.

Methods for making nanoporous energy chip materials and energy chips are described here. In general, these methods comprise providing a sol-gel derived monolith that, in turn, comprises an open network of pores, and at least partially or completely filling the network of pores with a conductive material to form a conductive network. The methods may further comprise a step of removing completely or partially the material of the sol-gel derived monolith to create a stand-alone conductive network or substantially stand-alone conductive network. The monoliths used in the methods may be derived from any suitable sol-gel, but in some variations, the monoliths are derived from silica sol-gels.

Some of these methods for making energy chips may comprise selecting the sol-gel derived monolith to have a predetermined average pore size and/or pore size distribution, e.g., an average pore size and/or pore size distribution selected to accommodate an ionic species of the electrolyte. For example, the methods may comprise selecting sol-gel derived monoliths having an average pore size in a range from about 0.3 nm to about 30 nm, about 0.3 nm to about 20 nm, or about 0.3 nm to about 10 nm. Further, sol-gel derived monoliths may be selected to have a pore size distribution such that at least about 50% of pores are within about 30%, or within about 20% of an average pore size.

The sol-gel derived monoliths may be made by methods comprising casting the gel formulation into a mold or container having multiple stacked layers of a hydrophobic material (such as sheets made of polytetrafluoroethylene), for example, as described in U.S. patent application Ser. No. 61/638,404 entitled “Methods and Apparatus for Casting Sol-Gel Wafers” (Attorney Docket Number 64334-30003.01), which is incorporated herein by reference in its entirety. The sol-gel derived monoliths produced may have a thickness of about 300 microns, about 150 microns, about 100 microns, about 80 microns, or less. Additionally, the sol-gel derived monoliths may have a uniform thickness, or at least a substantially uniform thickness. For example, thickness of a sol-gel derived monolith across different portions of the monolith may vary by less than 10%, less than 5%, less than 3%, less than 2%, or less than 1% of the thickness of the monolith. In some embodiments, the sol-gel derived monolith may be substantially flat. For example, the peak-to-reference flatness deviation across different portions of the monolith is less than 10% of the thickness of the monolith. In some embodiments, the peak-to-valley roughness of the sol-gel derived monolith surface may be less than 10% of the thickness of the monolith. The monoliths may be molded into any desired shape, for example circles, rectangles, and the like.

A sol-gel derived monolith having a preselected average pore size and/or a pore size distribution may be formed by reacting a sol-gel precursor with water in the presence of a catalyst, and controlling a rate of gelation with the catalyst. The catalyst may comprise hydrofluoric acid and, in some cases, the catalyst may comprise a second acid in addition to the hydrofluoric acid. A molar ratio of hydrofluoric acid to the precursor may be increased to increase an average pore size. If present, the second acid may be any suitable acid, but in some variations may be selected from the group consisting of HCl, HNO₃, H₂SO₄, organic acids, and combinations thereof. In some cases, the second acid may be a weak acid having a first pKₐ that is about 2 or greater, e.g., about 2 to about 5, or about 2 to about 4.

Additional steps include providing a sol-gel derived monolith comprising an open pore network, at least partially filling the open pore network with a conductive material, and selectively removing the sol-gel derived monolith to provide a conductive energy chip. In some variations, at least partially filling comprises impregnating a material into the open pore network, and subsequently converting the material into a conductive material.

In these methods, at least partially filling the open pore network may comprise impregnating the open pore network with a colloidal solution comprising conductive particles, e.g., metal and/or metal oxide particles. In other variations, at least partially filling the open pore network may comprise impregnating the open pore network with one or more precursors to a conductive polymer, and polymerizing the one or more precursors in situ to form a conductive energy chip comprising the conductive polymer.

In the methods, impregnating the open pore network may comprise synthesizing graphite or a graphite-like material (e.g., conductive carbon) within the pore structure, e.g., by polymerizing a polymer material made from the precursors resorcinol and formaldehyde, furfural, furfuryl alcohol (2-furylmethanol), polyfurfuryl alcohol, sucrose, glucose or melamine within the open pore network. In some circumstances, the open pore network may be impregnated partially or fully with a colloidal solution of a metal, the monolith may be dried to remove liquid from the colloidal solution, and the metal particles may be coalesced together, e.g., by melting or using rapid thermal processing, to form the conductive network in the open pore network. The material of the sol-gel derived monolith is removed to create a stand-alone or substantially alone conductive network.

Certain variations of these methods may be used to form energy chips having a conductive surface area of at least about 800 m²/g, at least about 1000 m²/g, at least about 1200 m²/g, at least about 1500 m²/g, at least about 1800 m²/g, at least about 2000 m²/g, or even higher, e.g., at least about 3000 m²/g, at least about 4000 m²/g, or at least about 5000 m²/g.

Energy chips made or obtainable by any of the methods described herein, and energy chips equivalent to any of the energy chips made by any of the methods described herein are provided. In some variations, the energy chips comprise a continuous skeletal framework formed of a conductive material. In some variations, the energy chips comprise a continuous skeletal framework formed of a conductive material that is formed using a sol-gel derived monolith as a template.

It is to be understood that one, some, or all of the properties of the various embodiments described herein may be combined to form other embodiments of the present invention. These and other aspects of the invention will become apparent to one of skill in the art.

### BRIEF DESCRIPTION OF THE FIGURES

FIG. 1 illustrates an exemplary process for making high surface area energy chips.

FIG. 2-A illustrates a porous carbon monolith with a thickness of 100 microns. FIG. 2-B shows a side view of the monolith demonstrating the flatness of the monolith.

FIG. 3 illustrates a graph showing the pore size distribution of silica template and imaged carbon energy chip. Y-Axis is dV(d), which is the pore volume per unit diameter interval.

FIGS. 4-A and 4-B illustrate cyclic voltammograms at a scan rate of 1 mV/s for: (4-A) single electrode in 5 MH₂SO₄, and (4-B) button cell device with ionic liquid and organic electrolyte.

### DETAILED DESCRIPTION

High surface area energy chips that can be used as electrodes are provided herein. The energy chips may be used as electrodes in a variety of energy storage devices such as capacitors, ultracapacitors, batteries, and fuel cells. Monolithic electrodes/capacitors could reduce ESR by eliminating binder and particle contact resistance.

As used herein, the terms “nanoporous materials,” “nanoporous electrodes,” and “nanoporous energy chips” are meant to encompass structures having pores (“nanopores”) having a dimension, e.g., a cross-sectional diameter, in a range from about 0.1 nm to about 100 nm. “Nanoparticles” as used herein is meant to encompass materials having a cross-sectional dimension, e.g., a diameter, in a range from about 0.1 nm to about 100 nm.

Ranges as used herein are meant to be inclusive of any end points to the ranges indicated, as well as numerical values in between the end points.

It should also be noted that as used herein and in the claims, the singular forms “a,” “an,” and “the” include plural referents unless the context clearly indicates otherwise.

It is understood that aspect and variations of the embodiments described herein include “consisting” and/or “consisting essentially of” aspects and variations.

In some variations, reference to “about” a value or parameter refers to variation in the numerical quantity that can occur, for example, through typical measuring and handling procedures used; through inadvertent error in these procedures; and through differences in the manufacture, source, or purity of the compounds employed to make the compositions or carry out the methods. Reference to “about” a value or parameter herein includes (and describes) embodiments that are directed to that value or parameter per se. For example, description referring to “about X” includes description of “X”.

As used herein “average pore size” is meant to encompass any suitable representative measure of a dimension of a population of pores, e.g., a mean, median, and/or mode cross-sectional dimension such as a radius or diameter of that population of pores. The mean pore size, median pore size, and mode pore size of a pore size distribution in a monolith may in some cases be essentially equivalent, e.g., by virtue of a very narrow and/or symmetrical pore size distribution.

For convenience only, the following description includes different headings. However, it should be understood that these organizational headings are not meant to be limiting in any way. For example, any of the energy chips or electrodes described herein may be used in connection with any of the energy storage devices or systems described herein, and any of the energy storage devices described herein may be used in connection with any of the systems described herein.

### I. Nanoporous Energy Chips as Electrodes

Nanoporous energy chips with high surface area that can be used to make electrodes are described herein. In general, nanoporous energy chips may comprise a conductive material, wherein the conductive material is monolithic and comprises an open network of pores having an average pore diameter between about 0.3 nm and about 30 nm, and wherein the conductive material forms a thin chip having a thickness of about 300 microns or less. In some embodiments, the thickness across different portions of the chip varies by less than 10% of the thickness. In some embodiments, the thin chip is substantially flat. For example, the peak-to-reference flatness deviation across different portions of the chip is less than 10% of the thickness of the chip. In some embodiments, the peak-to-valley roughness of the chip surface may be less than 10% of the thickness of the chip.

In general, the energy chips may be made using a sol-gel derived monolith comprising an open network of pores, where the open pore network has been made to be conductive. The high surface area of the open network of pores can thus be used as a substrate or a template for the conductive filling that makes up the conductive backbone of the energy chip. The open network of pores in the monolith may be at least partially filled (including substantially or completely filled) with a conductive material. The sol-gel derived monolith material may either be left more or less intact in the energy chips, e.g., to support the conductive network, or the monolith material may be removed, e.g., dissolved, to leave behind the conductive framework that has been formed in the open pore network.

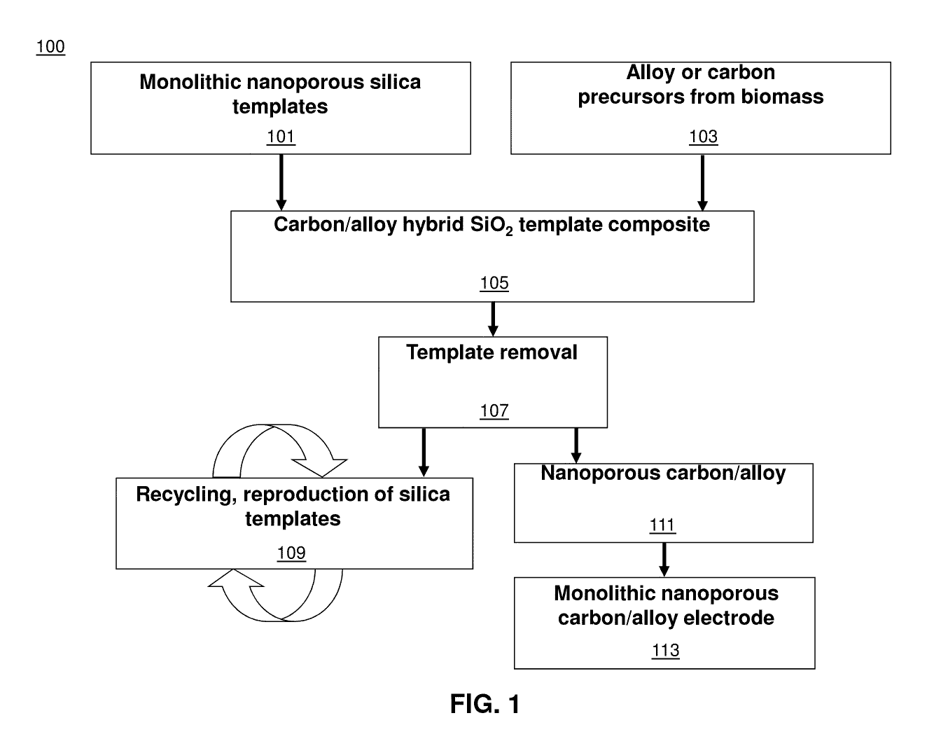

FIG. 1 illustrates an exemplary process 100 for making a monolithic nanoporous carbon/alloy electrode 113. Generally, a monolithic nanoporous silica template 101, for example, a silica sol-gel derived monolith as described herein, may be filled with a conductive material, such as an alloy or carbon precursor 103, to form a carbon/alloy hybrid template composite 105. The template may then be removed 107 (e.g., dissolved), leaving behind a nanoporous carbon/alloy 111 formed in the nanopores of the template. The nanoporous carbon/alloy 111 may be used in an energy storage device as a monolithic nanoporous carbon/alloy electrode 113. Since the template may be destroyed during the template removal process, additional templates may be produced 109. Additionally, the material removed at 107 may be recycled at 109. For example, after the silica template is dissolved into a solution, a silica powder Si(OH)₄ can be precipitated from the solution by adding an acid (e.g. HCl). To obtain the SiO₂, the silica powder needs to be dried and then purified. The purified SiO₂ can be mixed with absolute ethanol to produce TEOS, which is a silica precursor in our sol-gel processing to make monolithic nanoporous silica template. The details of each step will be described in greater detail below. It should be noted that the steps described above need not be performed in any particular order, and steps may be combined together. For example, the steps may be reversed, or the steps may be combined into a single step, or the steps may be completed simultaneously. Each of the steps in the methods is described in more detail below.

The sol-gel derived monolith used to form the energy chips may be derived from any suitable sol-gel, e.g., a silica sol-gel derived monolith. The monolith may be selected to have any desired characteristic or combination of characteristics, e.g., composition, average pore size, pore size distribution, surface area, or any combination thereof. By preselecting an average pore size, pore size distribution, or surface area, these properties may be at least partially mapped onto the conductive framework formed in the open pore network, thus affecting a resulting conductive surface area of the energy chip.

Generally, a sol-gel process starts with forming a colloidal solution (a “sol” phase), and hydrolyzing and polymerizing the sol phase to form a solid but wet and porous “gel” phase. The gel phase can be dried in a controlled manner, but generally not under supercritical conditions, so that fluid is removed to leave behind a dry monolithic matrix having an open network of pores (a xerogel). The term “xerogel” as used herein is meant to refer to a gel monolith that has been dried under non-supercritical temperature and pressure conditions. The dry gel monolith can then be calcined to form a solid glass-phase monolith with connected open pores. The dry gel monolith can be further densified, e.g., sintered, at elevated temperatures to convert the monolith into a glass or ceramic.

In general, the microstructure of sol-gel derived monoliths that may be used in the energy chips described herein may be characterized in terms of a total pore volume, referring to a total volume of pores per unit mass, a surface area, referring to a surface area within the open network of pores per unit mass, a porosity, referring to fraction of the total volume of a monolith occupied by open pores, an average pore size, referring to an average (e.g., mean, median or mode) cross-sectional dimension (e.g., diameter or radius) of pores in a monolith, and a pore size distribution. The bulk surface area of a monolith may be measured in m²/g, and may be measured for example by using B.E.T. (Brunauer, Emmett and Teller) surface analysis techniques. In general, multiple point B.E.T. analysis may be performed to determine the bulk surface area. An average pore size, a pore size distribution, and a total pore volume may be measured by an analyzer capable of resolving pore sizes to 0.3 nm or smaller, e.g., Quantachrome Quadrasorb™ SI-Krypton/Micropore Surface Area and Pore Size Analyzer, available from Quantachrome Instruments, Quantachrome Corporation (http://www.quantachrome.com, last visited May 11, 2008). The total pore volume may be measured in cm³/g, and is the inverse of the bulk density of a monolith.

A population of pores can be modeled as a set of spheres each having a diameter (d) equal to an average pore size for that population, which may be measured with a pore size analyzer as described above, an individual pore surface area (A=π·d²), and an individual pore volume (V=(⅙)π·d³). A calculated bulk surface area (SA) may be determined using the density ρ of a material making up the sol-gel matrix (e.g., for silica sol-gel, the density of silica forming the matrix is 2.1-2.2 g/cm³) and the following relationship in Equation 1:

SA=(1/ρ)[A/V]. (Eq. 1).

A calculated bulk density (ρ_{B}) of the monolith may be determined from the total pore volume (TPV) and the density ρ of a material making up the sol-gel matrix using the following relationship in Equation 2:

ρ_{B}=1/[(1/ρ)+TPV] (Eq. 2).

Thus, the fraction of pores (porosity), or % pores (by volume) in a monolith may be given by TPV/[(1/ρ)+TPV].

In general, the sol-gel derived monoliths described herein can be formed by hydrolyzing a precursor. The microstructure of the sol-gel derived monoliths described here may be affected, and therefore controlled by, rates of hydrolysis and polymerization. The precursor can be any suitable precursor, e.g., a metal- or metalloid-containing compound having ligands or side groups that can be hydrolyzed to form a sol, and then polymerized (gelled) to form a sol-gel. As is discussed in more detail herein, the hydrolysis and polymerization process can be catalyzed using a catalyst in solution.

An exemplary method for forming a sol-gel derived monolith (such as a silica sol-gel derived monolith) comprises preparing a precursor solution and preparing a catalyst solution. The precursor solution and the catalyst solution may be mixed together to form a reaction. The solution used in the reaction mixture may be aqueous, or may comprise one or water-miscible organic solvents in combination with water. For example, an alcohol such as methanol, ethanol, or any alcohol having the general formula CₙH₂ₙ₊₁OH, where n may be for example 0 to 12. Alternatively or in addition, formamide may be used in reaction mixture. The hydrolysis and polymerization reaction process may be allowed to proceed. After the wet gel is formed, the gel may be dried to form a monolith. It should be noted that the steps described above need not be performed in any particular order, and steps may be combined together. For example, the steps may be reversed, or the steps may be combined into a single step, or the steps may be completed simultaneously. Each of the steps in the methods is described in more detail below.

In some variations, the methods of making a silica sol-gel derived monolith comprising hydrolyzing a SiO₂ precursor with water in the presence of a catalyst to form a sol; gelling the sol; and drying the gelled sol. In some variations, the catalyst is preselected to obtain a porous SiO₂-containing monolith having a pore volume of between about 0.3 cm³/g to about 2.0 cm³/g, and a predetermined average pore diameter in a range from about 0.3 nm to about 30 nm with at least about 60% of pores having a pore size within about 20% of the average pore size.

Non-limiting examples of hydrolyzable side group that can be used in precursors include hydroxyl, alkoxy, halo, and amino side groups. In many cases, silica (SiO₂) sol-gels may be formed, e.g., using alkylorthosilicate, fluoralkoxysilane, or chloroalkoxysilane precursors. However, in other cases, sol-gels based on germanium oxide, zirconia, titania, niobium oxide, tantalum oxide, tungsten oxide, tin oxide, hafnium oxide, alumina, or combinations thereof may be formed using appropriate precursors. For example, germanium alkoxides, e.g., tetraethylorthogermanium (TEOG), zirconium alkoxides, titanium alkoxides, vanadium alkoxides, or aluminum alkoxides may be used as precursors to form sol-gels incorporating the respective metal or metalloid elements.

As stated above, silica sol-gels may be formed using alkylorthosilicates as precursors, e.g., tetraethylorthosilicate (TEOS) or tetramethylorthosilicate (TMOS). In general, the stoichiometric hydrolysis reaction to form the sol can be described as:

(RO)₄Si+4H₂O→4ROH+Si(OH)₄,

where R may for example be an ethyl group or a methyl group. Following this hydrolysis step, gelation can occur, in which the Si(OH)₄ condenses and polymerizes to form a network of SiO₂ and H₂O. The SiO₂ network so formed comprising open-necked pores, and H₂O may be present in the open pores. The reaction as described above is aqueous, and may comprise one or water-miscible organic solvent in combination with water. For example, an alcohol such as methanol, ethanol, or any alcohol having the general formula CₙH₂ₙ₊₁OH, where n may be for example 0 to 12. Alternatively or in addition, formamide may be used in the hydrolysis of the precursors. Two competing mechanisms may be operative that affect the microstructure of the monolith: formation of isolated silica particles, and formation of silica chains that form a fibril-like network.

The SiO₂ precursor may be hydrolyzed under either nonstoichiometric or stoichiometric hydrolysis conditions. In some variations, the molar ratio of water to precursor is about 3:1 or less, about 2.5:1 or less, about 2.25:1 or less, or about 2:1. In some variations, hydrolysis is performed directly with water and no solvent (such as an alcohol, including methanol and ethanol) is added into the reaction.

The microstructure of a sol-gel derived monolith that can be used to form an energy chip for an energy storage device may be controlled by varying any one or any combination of several reaction parameters. For example, U.S. Pat. No. 4,851,150, U.S. Pat. No. 4,849,378, U.S. Pat. No. 5,264,197, U.S. Pat. No. 6,884,822, U.S. Pat. No. 7,001,568, U.S. Pat. No. 7,125,912, PCT WO 2006/068797, PCT WO 2009/152229, and PCT WO 2009/152239, each of which is hereby incorporated by reference herein in its entirety, describe a variety of methods for making sol-gel derived monoliths wherein in one or more reaction parameters is varied to control an average pore size and/or a pore size distribution.

Catalysts can be used to adjust, e.g., increase, rates of hydrolysis and polymerization, and correspondingly adjust the rate of gel formation, which can affect the microstructure in the resulting monolith. Further, a reaction temperature or temperature profile may be used to adjust a rate of gel formation. A catalyst may be an acid or a base. In some variations, the catalyst comprises an organic acid (such as formic acid, acetic acid, citric acid, or mixtures thereof). In some variations, a catalyst may comprise a first acid and a second acid, where the second acid catalyzes the hydrolysis reaction, and the first acid is capable of etching, dissolving, and/or redepositing in the sol matrix (e.g., a SiO₂ matrix), which may have the effect of increasing size of redeposited nanoparticles in the sol-gel matrix formation, leading to correspondingly increased nanopores size. Thus, the second acid of the catalyst may be added first to the sol-gel precursors to activate hydrolysis, and the first acid may be added subsequently to tune the pore size in the sol-gel. In other variations, the first and second acids of the catalyst may be added simultaneously. Of course, the first acid and/or the second acid of the catalyst may comprise a mixture of acids. In certain instances, the first acid, e.g., a matrix (e.g., SiO₂) dissolving component, of the catalyst may comprise hydrofluoric acid (HF), or a source of HF. HF sources that may be used include suitable fluorine-containing compounds that can produce HF during hydrolysis, or during polymerization (gelation).

Fine tuning of an average pore size and/or a pore size distribution in the resulting monolith may be accomplished by varying any one or any combination of the following reaction conditions: an amount of HF relative to a precursor; an amount of H₂O relative to a precursor; an amount of a solvent relative to a precursor; varying an amount of a second acid relative to a precursor; an amount of a second acid relative to an amount of HF; and/or a reaction temperature. The relative amounts of the precursor, H₂O and solvent, if present, may be stoichiometric or nonstoichiometric.

Further, the properties of the second acid, if used, may be selected to control at least one of an average pore size and a pore size distribution, and in some cases an average pore size and a pore size distribution associated with that average pore size. For example, a strong acid, e.g., an acid having a first pKₐ that is lower about −1 or lower, e.g., HCl, H₂SO₄, HNO₃, or a combination thereof, may be used as a second acid in addition to HF to catalyze the hydrolysis and/or the gelation processes. In some variations, a weak acid, e.g., an acid having a first pKₐ that is about 2 or greater, e.g., a first pKₐ of about 2 to about 5, or about 2 to about 4. For example, citric acid, acetic acid, formic acid, or combinations thereof, may be used as a second acid in addition to HF as a catalyst. In some variations, the second acid is an organic acid (e.g., citric acid, acetic acid, formic acid) which can be removed or burned from the gelled sol during the drying process. In certain variations, an intermediate acid, e.g., an acid having a first pKₐ that is between −1 and 2, e.g., oxalic acid, mellitic acid, or ketomalonic acid, may be used in combination with HF.

In general, narrow pore size distributions with a tunable average pore size may be produced by hydrolyzing and polymerizing the precursor in the presence of a relatively low amount of HF compared to the precursor. For example, if a non-stoichiometric amount of water relative to precursor is used, e.g., by using 2 moles of water relative to one mole of a precursor such as TEOS or TMOS, the molar ratio of HF to the precursor used in the methods described herein may be about 0.01:1 or less, e.g., about 0.01:1, about 0.009:1, about 0.008:1, about 0.007:1, about 0.006:1, about 0.005:1, about 0.004:1, about 0.003:1, about 0.002:1, or about 0.001:1. In another example, if a non-stoichiometric amount of water relative to a precursor is used, e.g., 2.25 moles of water relative to one mole of a precursor such as TEOS or TMOS, the molar ratio of HF to the precursor used in the methods may be about 0.1:1, about 0.09:1, about 0.085:1, about 0.08:1, about 0.075:1, about 0.07:1, about 0.065:1, about 0.06:1, about 0.055:1, about 0.05:1, about 0.045:1, or about 0.4:1. For these non-stoichiometric situations, a molar ratio of the second acid to the starting material (e.g., the precursor) may be about 0.075:1, about 0.07:1, about 0.065:1, about 0.06:1, about 0.055:1, about 0.05:1, about 0.04:1, about 0.03:1, about 0.02:1, about 0.018:1, about 0.015:1, about 0.01:1, about 0.008:1, about 0.005:1, about 0.003:1, or about 0.001:1. The second acid in these instances may be any suitable acid, e.g., a strong acid (such as HCl, H₂SO₄, HNO₃, or a combination thereof), a weak acid (such as citric acid, acetic acid, formic acid, or a combination thereof), or an intermediate acid.

If a stoichiometric amount of water relative to a precursor is used, a molar ratio of HF to precursor that is about 0.01:1 or less may be used, e.g., about 0.01:1, about 0.009:1, about 0.008:1, about 0.007:1, about 0.006:1, about 0.005:1, about 0.004:1, about 0.003:1, about 0.002:1, about 0.001:1, about 0.0005:1, or even less, and in some cases no HF may be used. In general, an amount of HF used in a catalyst may be increased to increase an average pore size. To achieve fine control of pore size and/or pore size distribution, the amount of HF may be adjusted using fine increments, e.g., by changing the molar ratio of HF relative to the precursor in increments of about 0.005 or about 0.001. A molar ratio of a second acid may be about 0.01:1 or less, e.g., about 0.01:1, about 0.009:1, about 0.008:1, about 0.007:1, about 0.006:1, about 0.005:1, or even less, and in some cases, no second acid may be used. Here again, the second acid may be any suitable acid, e.g., a strong acid such as HCl, H₂SO₄, HNO₃, or a combination thereof, a weak acid, or an intermediate acid.

In certain variations, under either nonstoichiometric or stoichiometric hydrolysis conditions, the second acid may be a weak acid that has a first pKₐ of about 2 or higher, or about 3 or higher. Some of these weak acids may be organic acids, or small molecule acids. In some cases, the first pKₐ of the weak acid may be about 2 to about 5, e.g., about 2, about 2.5, about 3, about 3.5, about 4, about 4.5, or about 5. In certain variations, the first pKₐ of the weak acid may be about 2 to about 4. Non-limiting examples of weak acids that may be used include citric acid, acetic acid, formic acid, ascorbic acid, succinic acid, benzoic acid, acetoacetic acid, malic acid, pyruvic acid, vinyl acetic acid, tartartic acid, fumaric acid, phthalic acid, isophthalic acid, terephthalic acid, itaconic acid, hemimellitic acid, trimellitic acid, malonic acid, dicarboxylic acids such as methyl dicarboxylic acid, ethyl dicarboxylic acid, n-propyl dicarboxylic acid, isopropyl dicarboxylic acid, dimethyl dicarboxylic acid, methyl ethyl dicarboxylic acid, ethyl n-propyl dicarboxylic acid, di-n-propyl dicarboxylic acid, glutaric acid, adipic acid, pimelic acid, suberic acid, amino acids such as alanine, aspartic acid and glutamic acid.

For any of the methods described here, a temperature or temperature profile used in the hydrolysis and polymerization process used in making the wet porous gel monoliths may be varied to tune a reaction rate, which can in turn affect monolith microstructure. Thus, different temperatures or temperature profiles may be used, and may depend on a catalyst selected. In some situations, a temperature or temperature ramp that includes temperatures below ambient may be used for gelation, e.g., as described in U.S. Pat. No. 6,884,822, which is incorporated herein by reference in its entirety. In other instances, elevated reaction temperatures may be used, which may be at least in part due to exothermic hydrolysis reaction. Reaction temperatures may range from about 0° C. to about 80° C., or from about 15° C. to about 125° C., or from about 45° C. to about 100° C. In some cases, a reaction temperature may be naturally ramped up during the hydrolysis process due to the exothermic reaction, e.g., from about 0° C. to about 100° C. over a period of about 1 to 2 hours. For example, an exothermic hydrolysis reaction solution may be mixed while the reaction temperature ramped from about 0° C. to about 70° C. over a period of about 1 to 2 hours. The mixture may then be cast into an appropriate mold and held at an appropriate temperature, e.g., from about 0° C. to about 70° C. (such as about 33° C.) for an additional 1 to 30 hours to allow further gelation. In some cases, the mixture may be held in a mold at about 20° C. for 1 to 2 hours to allow gelation, held at about 20° C. for an additional 12 to 24 hours to allow the gelled sol to begin shrinkage (e.g., about 0.5% to about 5% volume shrinkage), and then removed from the mold, or remained in the mold for further drying process.

As indicated above, the wet, porous monoliths as prepared by any of the methods provided above may be formed in a mold so that it may be dried in a desired shape and configuration. Any suitable molding method or technique, and any suitable drying method or technique as described herein, now known, or later developed, may be used to form and dry the wet gels formed herein. For example, the apparatus and methods described in U.S. patent application Ser. No. 61/638,404 entitled “Methods and Apparatus for Casting Sol-Gel Wafers” (Attorney Docket Number 64334-30003.01) may be used. In some variations, the apparatus for forming sol-gel derived monoliths comprises: a first separating layer; a first well layer disposed on the first separating layer, the first well layer having at least one well; and a second separating layer disposed on the first well layer opposite the first separating layer, wherein the at least one well is covered by the first separating layer and the second separating layer. The layers are made of hydrophobic low-friction materials, for example, polytetrafluoroethylene (e.g., Teflon™). To make the sol-gel derived monolith, the following steps may be used: inserting alternating separator and well layers into a container containing a gel formulation; applying pressure to the stack of layers; and allowing the gel formulation to form a gel.

Suitable examples of drying techniques and methods are described in U.S. Pat. No. 6,884,822 entitled “Sol-Gel Process Utilizing Reduced Mixing Temperature,” U.S. Pat. No. 6,620,368 entitled, U.S. Pat. No. 5,264,197 entitled “Sol-Gel Process for Providing a Tailored Gel Microstructure,” U.S. Pat. No. 4,849,378 entitled “Ultraporous Gel Monoliths Having Predetermined Pore Sizes and Their Production,” U.S. Pat. No. 4,851,150 entitled “Drying Control Additives for Rapid Production of Large Sol-Gel Derived Silicon, Boron and Sodium Containing Monoliths,” U.S. Pat. No. 4,851,373 entitled “Large Sol-Gel SiO₂ Monoliths Containing Transition Metal and Their Production,” U.S. Pat. No. 5,071,674 entitled “Method for Producing Large Silica Sol-Gel Doped with Inorganic and Organic Compounds,” U.S. Pat. No. 5,196,382 entitled “Method for Production of Large Sol-Gel SiO₂ Containing Monoliths of Silica with and without Transition Metals,” U.S. Pat. No. 5,023,208 entitled “Sol-Gel Process for Glass and Ceramic Articles,” U.S. Pat. No. 5,243,769 entitled “Process for Rapidly Drying a Wet, Porous Gel Monolith,” U.S. Pat. No. 7,000,885, entitled “Apparatus and Method for Forming a Sol-Gel Monolith Utilizing Multiple Casting,” U.S. Pat. No. 7,001,568, entitled “Method of Removing Liquid from Pores of a Sol-Gel Monolith,” U.S. Pat. No. 7,026,362, entitled “Sol-Gel Process Utilizing Reduced Mixing Temperatures,” U.S. Pat. No. 7,125,912, entitled “Doped Sol-Gel Materials and Method of Manufacture Utilizing Reduced Mixing Temperatures,” and U.S. patent application Ser. No. 61/638,404 entitled “Methods and Apparatus for Casting Sol-Gel Wafers” (Attorney Docket Number 64334-30003.01), each of which is incorporated herein by reference in its entirety.

In general, a wet, porous monolith that has been placed in a mold may be held in a storage area under generally ambient conditions for about one to three days. After this initial period, the monolith may be removed from the mold or remained in the mold. Subsequently, a monolith may be dried under controlled, but not necessarily supercritical, drying conditions. The drying conditions can remove liquid, e.g., water and/or a solvent such as an alcohol from the interior of the porous network under controlled conditions such that the monolith does not crack and the integrity of the monolith remains intact. During drying, the monolith shrinks, and capillary forces in the pores increase as liquid is drawn out. Thus, any suitable drying temperature profile and/or drying atmosphere may be used with the monoliths formed such to avoid cracking of the monoliths, e.g., by keeping capillary forces due to the liquid being extracted below the limit of the pore walls to withstand such forces. The temperature profile used for drying can be adjusted so that the evaporation rate of liquid from the pores is approximately the same as or less than the diffusion rate of the liquid through the pores. In some cases, a modulated temperature profile (temperature cycling) may be used. Temperature cycling in some instances may reduce a drying time. Drying profiles may be used that allow drying of a monolith over a time period of a few days or less, e.g., within a week, or within 5 days, or within 3 days, or within 2 days, or within 1 day. As is described in more detail below, the extent of reaction (e.g., shrinkage) and drying may be monitored by weight loss, vapor pressure and/or physical (e.g., microscopic) inspection.

For example, monoliths as described here may be dried using the methods similar to those described in U.S. Pat. No. 6,620,368 which has already been incorporated herein by reference in its entirety. That is, a portion of the liquid (e.g., water and/or alcohol) in the pores of the wet monolith may be removed while the gel remains wet at least in an outer circumferential outer region of the monolith. Thus, the gel can dry more or less from the inside out, e.g., the outer peripheral region of the monolith may dry after an inner core region of the monolith has substantially dried.

In some cases, drying methods and techniques may be used that are similar to those described in U.S. Pat. No. 7,001,568, which has already been incorporated herein by reference in its entirety. That is, the monoliths may be dried by removing a portion of liquid, e.g., water and/or an alcohol such as ethanol, from pores of a body of a gel monolith while both an inner core region and an outer peripheral region of the gel remain wet. The gel may be allowed to shrink and become denser while the inner core region and the outer peripheral region remain wet. After this initial partial drying procedure, the remainder of the liquid may be removed from the monolith by applying a modulated temperature gradient between the outer peripheral region and the inner core region.

As stated above, any suitable method, technique, instrument, or combination thereof may be used for monitoring the extent of reaction and corresponding monolith shrinkage, e.g., mass loss, vapor pressure, and/or physical inspection. It may be desired to monitor shrinkage using a relatively precise technique, as incomplete or non-uniform reaction or drying may lead to cracking, or may lead to broadened distributions of pore sizes. For example, shrinkage of the monolith may be monitored locally and microscopically over its body to gauge an extent and uniformity of shrinkage. Such microscopic monitoring may be conducted using any suitable tools or technique. Any technique that is capable of detecting and resolving micron sized or submicron sized distance changes may be suitable. For example, any type of displacement sensor that is capable of about 1 μm, about 0.5 μm, about 0.1 μm, or even finer resolution may be used. Contact or non-contact techniques may be used to monitor the drying of a monolith. Physical shrinkage measurements may be made on a continuous basis, or may be made at selected time intervals. Multiple displacement sensors may used, e.g., to measure displacement along different dimension such as a cross-sectional dimension (e.g., a width, diameter or radius) or a longitudinal dimension (e.g., a height or length). In some cases, multiple displacement sensors may be used to monitor shrinkage in different regions of a monolith. Linear, two-dimensional, or three-dimensional displacement sensing tools may be used. The monolith may be placed on a vibration-controlled support, e.g., an optical table, to improve accuracy and precision of displacement measurements.

Non-limiting examples of contact-type displacement sensors that may be used to monitor shrinkage of a monolith include dial indicators, linear variable differential transformers (LVDT), and differential variable reluctance transformers (DVRT). Non-limiting examples of non-contact displacement sensors that may be used include eddy-current (inductive) type magnetic field displacement sensors and optical displacement sensors. For example, any commercially-available laser displacement sensor that is capable of 1 μm or less resolution may be used. Laser displacement sensors may be scanning, e.g., to monitor a surface, or non-scanning varieties, e.g., to monitor a targeted position. Non-limiting examples of suitable vendors for contact and/or non-contact displacement sensors include Keyence, Inc. (www.sensorcentral.com), Acuity, Inc. (www.acuity.com), Micro-Epsilon, Inc. (www.micro-epsilon.com), MTI Instruments, Inc. (www.mtiinstruments.com), Honeywell, Inc. (www.honeywell.com/sensing), Baumer, Ltd. (www.baumerelectric.com), Banner Engineering, Inc. (www.bannerengineering.com), and Microstrain, Inc. (www.microstrain.com). It may be desired to use a displacement measurement technique that is substantially temperature-sensitive or allows for temperature compensation, e.g., an optical displacement t sensor or a DVRT. Combinations of displacement sensor technologies may be used, e.g., one type may be used to monitor a longitudinal dimension, whereas another type of sensor may be used to monitor a cross-sectional dimension.

Thus, the shrinkage of one or more dimensions and/or one or more regions of a monolith may be monitored to detect a plateau in the shrinkage process. In many cases, shrinkage may be monitored at multiple positions to detect a plateau has been reached throughout the body of the monolith, instead of only in portions of the monolith. A plateau may be reached when shrinkage is less than about 100 ppm, less than about 5 ppm, less than about 1 ppm, or even less. For example, a plateau may be reached when dimensional changes are about 1 μm or less. In some cases, a relatively imprecise measurement technique such as mass loss may be used for monitoring an initial shrinkage phase, whereas a more precise monitoring technique as described above may be used for monitoring final shrinkage. The shrinkage may be carried out at a temperature in the range of about 70° C. to about 90° C. Generally, before reaching shrinkage plateau, no gas is used to purge the vapor out of the monolith.

Thus, the shrinkage and drying of the gels can be described in terms of a two phase treatment. In a first phase, the wet gel structure has reached its final shrinkage (e.g., monitored b physical displacement as described above) with its internal open pores still filled with its own pore liquid (e.g., molecular species such as water molecules and alcohol molecules). Thereafter, in a second phase, the monolith can be heated to remove any residual liquid in the pores. The heat treatment itself can include multiple heat treatment stages. In a first heat treatment stage, temperatures greater than the boiling point of the molecular species inside the porous gel structure may be used, e.g., to overcome capillary forces within the pores. In some cases, in this stage, a temperature ramp from about 80° C. to about 200° C., from about 90° C. to about 180° C., or from about 90° C. to about 120° C. may be used to drive off molecular water, alcohol (e.g., ethanol), and catalysts remaining in the pores. During the first heat treatment stage, the heating condition is sufficient to evaporate the molecular species from inside the pores, but is insufficient cause removal of chemisorbed molecular species. Thus, a temperature ramp from about 200° C. to about 450° C., or from about 180° C. to about 400° C. may be used to burn off molecular water, alcohol (e.g., ethanol), remaining in the pores in a second heat treatment stage, as is described in more detail below. No purging gas is used before the pore liquid is totally evaporated to become vapor phase. A temperature ramp used any of the heat treatment stages may depend on the dimensions, especially a thickness, of a monolith, but for a rod-shaped or brick-shaped monolith having a thickness of several cm, this temperature ramp may occur over about 1 hour to about 2 hours. After all the pore liquid becomes vapor phase, a nitrogen atmosphere (or inert gas such as helium or argon), or air atmosphere may be used to purge or exchange vaporized pore liquid out. At this stage, the temperature is increased from 120° C. to 180° C. to get rid of all and any molecular water and alcohol inside the pore of gel.

As stated above, in a second heat treatment stage, chemisorbed species that still remain in the pores may be burned off in an air atmosphere. Thus, the temperatures used in this stage of the heat treatment may be sufficient to burn off chemisorbed alcohol or other organic species such as higher molecular weight alcohols that are still present in the pores, but insufficient to cause the pores to close. For the this stage, air or N₂/O₂ combination may be introduced at about 140° C. to about 200° C. or about 180° C. to about 200° C. and the temperature increased to a baking temperature in a range from about 400° C. to about 800° C., e.g., about 400° C., about 450° C., about 500° C., about 600° C., or about 700° C. The baking time for the second stage of the heat treatment may be varied based on a thickness of a monolith. For example, a block-shaped or rod-like monolith having a thickness of several centimeters may be baked for about 2 to about 5 hours. In some cases, the second stage of the heat treatment can form hydroxyl reaction sites, e.g., at a density of about 4 to about 6 hydroxyl groups per nm².

In some variations, a method of drying the gels described herein is provided, the method comprising heating the gel that has reached shrinkage plateau at a temperature that the molecular species (including alcohol, water, and catalysts) are in vapor phase (e.g., at a temperature in the range of 90° C. to 120° C.); introducing a gas (such as nitrogen) to purge or exchange the vaporized molecular species out of the pores (e.g., at a temperature in the range of about 120° C. to about 180° C.); and burning the gel to remove chemisorbed species out the pores in the presence of N₂/O₂ combination or air (e.g., at a temperature in the range of about 140° C. to about 450° C.).

In certain variations, one or more additional components may be added during the hydrolysis and polymerization of the gels described herein. For example, one or more drying control agents may be used, such as those described in U.S. Pat. No. 4,851,150, which has already been incorporated herein by reference in its entirety. Further, one or more porogens may be added, such as those described in International Patent Publication No. WO 2006/068797, which has already been incorporated herein by reference in its entirety.

The sol-gel derived monolith (sol-gel wafers) used herein may be made using a mold as described in U.S. patent application Ser. No. 61/638,404 entitled “Methods and Apparatus for Casting Sol-Gel Wafers” (Attorney Docket Number 64334-30003.01). The mold may be formed of multiple low-friction layers, for example, layers made of Teflon™. The layers may alternate between solid layers and well layers, with a gel formulation placed in wells of each well layer. A force may be applied to the layers during the gelling process to produce a solid, but wet and porous gel in the shape of the wells of the mold. The gel may be further processed (e.g., within the mold or removed from the mold) to produce sol-gel derived monoliths having desired surface characteristics. The sol-gel derived monolith (wafers) produced using these molds may have a thickness of about 300 microns or less, about 150 microns or less, about 120 microns or less, about 100 microns or less, or about 80 microns or less. Additionally, the sol-gel may have a uniform thickness, or at least a substantially uniform thickness. For example, thickness of the sol-gel wafers across different portions of the wafer may vary by less than 10%, less than 9%, less than 8%, less than 7%, less than 6%, less than 5%, less than 3%, less than 2%, or less than 1% of the thickness of the wafer. The wafers may be formed into any desired shape, for example, a circle, rectangle, etc. Additionally, the gel formulation placed in wells of each layer may shrink depending on the particular gel formulation used. For example, the gel formulation may shrink by about 30%, about 40%, about 50%, about 60%, or any other amount. The shrinkage may be controlled in part by the concentration of the gel formulation or the amount of water in the sol gel. As such, the thickness of each well of the mold may be selected based at least in part on the shrinkage properties of the gel formulation and the desired thickness of the wafer.

The thickness of a sol gel wafer described herein may be measured by methods known in the art, such as using a digital caliper by Mitutoyo Corp. (Code:500-193 Model No: CD-12″ CP). The thickness of a wafer may be an average (e.g., a median, mean, or mode) of the thickness values measured at different portions of the wafer.

The sol gel wafers may be substantially flat across the wafer. For example, the peak-to-reference flatness deviation across different portions of the wafer is less than 10%, less than 9%, less than 8%, less than 7%, less than 6%, less than 5%, less than 4%, less than 3%, less than 2%, or less than 1% of the thickness of the wafer. The flatness of the electrode may be measured using methods known in the art, for example, using technology as applied for silicon wafers (e.g. using a Nanovea 750 system) (http://nanovea.com/Application%20Notes/Wafernatness.pdf). Flatness may be quantified by laying the wafer on a flat platform, which serves as reference plane for the measurement. The height difference between the top surface of the wafer and the reference plane at various points are measured.

Surface roughness of the wafer may be characterized by the fluctuation in height of the wafer's surface. Surface roughness can be measured by methods known in the art, such as by using a Zeta-20 instrument (http://www.zeta-inst.com/page/zeta-20-summary). In some embodiments, the peak-to-valley roughness of a dried sol gel wafer surface is less than 10%, less than 9%, less than 8%, less than 7%, less than 6%, less than 5%, less than 4%, less than 3%, less than 2%, or less than 1% of the thickness of the wafer.

The monoliths made according to the methods described herein may have microstructure having a desired microstructure and a desired surface area for the open network of pores. As stated above, the total pore volume of a monolith may be determined using a pore size analyzer such as a Quantachrome Quadrasorb™ SI Krypton/Micropore analyzer, and the bulk density of a monolith may then be calculated using the total pore volume and the density of the material making up the framework in the monolith. The monoliths according to the methods described here may have a total pore volume of at least about at least about 0.1 cm³/g, at least about 0.2 cm³/g, at least about 0.3 cm³/g, at least about 0.4 cm³/g, at least about 0.5 cm³/g, at least about 0.6 cm³/g, at least about 0.7 cm³/g, at least about 0.8 cm³/g, at least about 0.9 cm³/g, at least about 1 cm³/g, at least about 1.1 cm³/g, at least about 1.2 cm³/g, at least about 1.3 cm³/g, at least about 1.4 cm³/g, at least about 1.5 cm³/g, at least about 1.6 cm³/g, at least about 1.7 cm³/g, at least about 1.8 cm³/g, at least about 1.9 cm³/g, at least about 2.0 cm³/g, or even higher. Thus, some monoliths may have a total pore volume in a range from about 0.3 cm³/g to about 2 cm³/g, or from about 0.5 cm³/g to about 2 cm³/g, or from about 0.5 cm³/to about 1 cm³/g, or from about 1 cm³/g to about 2 cm³/g. A porosity of the monoliths may be about 30% to about 90% by volume, e.g., about 30% to about 80%, about 40% to about 80%, or about 45% to about 75%. In some variations, the porosity may be lower than about 30% by volume or higher than about 90% by volume, e.g., up to about 95% by volume.

An average pore size (such as average pore diameter) of the pores in the open pore network formed in the monoliths described herein may be tunable of a range from about 0.3 nm to about 300 nm, about 0.3 nm to about 100 nm, about 0.3 nm to about 50 nm, about 0.3 nm to about 30 nm, or about 0.3 nm to about 10 nm. For example average pore sizes of about 0.3 nm, about 0.5 nm, about 0.8 nm, about 1 nm, about 2 nm, about 3 nm, about 4 nm, about 5 nm, about 6 nm, about 7 nm, about 8 nm, about 9 nm, or about 10 nm may be preselected and achieved using the methods described herein. For any preselected average pore size achieved in the monoliths described herein, a relatively narrow distribution around that average may be achieved. For example, at least about 50%, at least about 60%, at least about 70%, or at least of about 75% of the pores may be within about 40%, within about 30%, within about 20%, or within about 10% of an average size. In certain variations, at least about 50% of the pores may be within about 1 nm, within about 0.5 nm, within about 0.2 nm, or within about 0.1 nm of an average pore size. As used herein “within” a designated percentage or designated amount of an average pore size is meant to encompass that percentage deviation or a lesser percentage deviation, or that amount of deviation or a lesser amount of deviation to either the higher side or a lower side of the average pore size. That is, a pore size distribution that is within about 20% of an average pore size is meant to encompass pore sizes in a range from the average pore size minus 20% of that average pore size to the average pore size plus 20% of that average pore size, inclusive.

Thus, some variations of monoliths may have an average pore size that can be selected in a range from about 0.3 nm to about 300 nm, or in a range from about 0.3 nm to about 100 nm, or in a range from about 0.3 nm to about 30 nm, or in a range from about 0.3 nm to about 10 nm, and a distribution such that at least about 50% or at least about 60% of the pores are within about 20% of the average pore size, or within about 10% of the average pore size. Certain variations may have even tighter pore size distributions, e.g., monoliths may have an average pore size selectable in a range from about 0.3 nm to about 30 nm or in a range from about 0.3 nm to about 10 nm, and have a distribution such that at least about 50% of pores are within about 10% of the average. For monoliths having relatively small average pore sizes, e.g., 5 nm or smaller, e.g., about 5 nm, about 4 nm, about 3 nm, about 2 nm, about 1 nm, about 0.5 nm, or about 0.3 nm, at least 50% of the pores may be within about 1 nm, about 0.5 nm, about 0.2 nm, or about 0.1 nm of the average.

In general, the surface area of a monolith increases for smaller particles sizes, and in particular when a pore size decreases below about 3 nm, the corresponding surface area increases rapidly, e.g., exponentially or approximately exponentially. The surface area of a monolith may be measured by using the B.E.T. surface area method, or may be calculated using an average pore size as described above (Eq. 1). In general, the surface area of a monolith increases for smaller particles sizes, and in particular when a pore size decreases below about 3 nm, the corresponding surface area increases rapidly in a nonlinear manner, e.g., exponentially or approximately exponentially. There, a bulk surface area (SA) in m²/g has been calculated for versus average pore diameter (D) as described above in connection with Eq. 1. Data point symbols indicate bulk surface areas measured by B.E.T. analysis. Monoliths with dramatically increased surface areas may be prepared by the methods described herein, e.g., where the average pore size may be controlled to be about 3 nm or smaller.

As shown, as a pore size decreases from about 3 nm to about 0.6 nm, the corresponding surface area increases from about 1000 m²/g to about 5000 m²/g, e.g., a five-fold increase. Monoliths with dramatically increased surface areas may be used for the high surface area energy chips described herein, where the average pore size may be controlled to be about 5 nm or smaller, or about 3 nm or smaller.

Thus, a surface area of the open pore network in the sol-gel derived monoliths used to make the high surface area energy chips described herein may be about 50 m²/g to about 5000 m²/g, or even higher, e.g., at least about 50 m²/g, at least about 100 m²/g, at least about 150 m²/g, at least about 200 m²/g, at least about 300 m²/g, at least about 400 m²/g, at least about 500 m²/g, at least about 600 m²/g, at least about 700 m²/g, at least about 800 m²/g, at least about 1000 m²/g, at least about 1200 m²/g, at least about 1400 m²/g, at least about 1600 m²/g, at least about 1800 m²/g, at least about 2000 m²/g, at least about 2200 m²/g, at least about 2400 m²/g, at least about 2600 m²/g, at least about 2800 m²/g, at least about 3000 m²/g, at least about 3500 m²/g, at least about 4000 m²/g, at least about 4500 m²/g, or at least about 5000 m²/g.

The surface area of the nanoporous monolith may be measured a Non-Local Density Functional Theory (NLDFT) method as described in M. Thommes, “Physical Adsorption Characterization of Ordered and Amorphous Mesoporus Materials” in Nanoporus Materials: Science and Engineering, G. Q. Lu, X. S. Zhao, Eds., Imperial College Press, Chapter 11 (2004).

Any sol gel derived monoliths or wafers described herein may be used as templates for making the energy chips. A conductive material or a material that can be converted into a conductive material by subsequent processing may be applied to (e.g., by impregnating) any suitably formed sol-gel derived monolith, e.g., a monolith as molded and dried, or a monolith that has been molded, dried, and subsequently processed. The material used for impregnating may comprise any suitable material, e.g., graphite, graphite-like conductive carbon carbide, carbon, activated carbon, conductive carbons derived from the polymerization and carbonization of carbon precursor materials, a metal such as platinum, nickel, gold, palladium, molybdenum, a metal oxide such as tin oxide, indium tin oxide, zinc oxide, zinc manganese dioxide, zinc manganese dioxide, oxy nickel hydroxide, lithium copper oxide, lithium manganese dioxide, lithium vanadium oxide, mercury oxide, molybdenum oxide, ruthenium oxide, tungsten oxide, manganese dioxide, silver oxide, nickel oxyhydroxide, aluminum doped zinc oxide, titanium oxide, vanadium pentoxide, sulfides such as molybdenum sulfide, tungsten sulfide, iron sulfide, lithium iron disulfide, nitrides such as tungsten nitride, molybdenum nitride, phosphates such as lithium iron phosphate, lithium iron fluorine phosphate, other materials such as zinc carbon, zinc chloride, lithium ion, lithium manganese spinel, lithium nickel manganese cobalt, lithium air, 5% vanadium-doped lithium iron phosphate olivine, metal hydrides, zinc air, silver zinc, lead acid, nickel cadmium, nickel metal hydride, nickel zinc, or combinations thereof, or conductive polymers such as poly(3-methylthiophene), polyaniline, poly-fluorophenylthiophene, polypyrrole, poly[3-(4-difluorophenylthiophene)], poly[3-(4-aminophenyl) propionic acid], poly[3-(3,4 difluorophenylthiophene)], 3,4-poly(ethylenedioxythiophene, diaminoanthraquinone, polyacetylene). As used herein, a “graphite-like” material is a carbon-based material that is similar to graphite but has a conductivity and a density approaching that of graphite. As the density of a graphite-like material is increased toward that of graphite, the conductivity of a graphite-like material correspondingly approaches that of graphite. A graphite-like material may contain more defects than graphite, or may contain impurities. Examples of carbon precursor materials include, but are not limited to, furfural, furfuryl alcohol (2-furylmethanol), polyfurfuryl alcohol, resorcinol formaldehyde, sucrose, glucose, melamine, and the like. As stated above, the energy chips may be used in a capacitor, an ultracapacitor, a fuel cell, or a battery and the energy chips may, based in part on choice of conductive material, be capable of being charged and discharged both or individually electrostatically or faradiacally. Additionally, the materials listed above are provided only as examples. It should be appreciated by one of ordinary skill in the art that other materials may be used to form electrodes and that any such material can be used.

Of course, the composition of the conductive composition filled into the open network of pores used in the energy chips can affect electrical properties of the energy chips described herein. For example, conductive material selection can affect the electrical conductivity of the energy chip, as well as energy-handling capabilities, e.g., whether the energy chip is suitable for relatively high voltages and/or relatively high currents. Further, conductive material selection can affect contact resistance of the energy chip, which can contribute to ESR.

In general, the conductive materials used to fill the open network of pores may be relatively uniform, e.g., to prevent high resistance regions that can lead to hot spots and subsequent failure. In some cases, the conductive materials used to fill the open network of pores may be uniform throughout an entire open network of pores of a sol-gel derived monolith. In other instances, the conductive materials used to fill the open network of pores may be non-uniform but still connected and conductive forming a conductive monolith network within the open network of pores.

In some instances, e.g., for high current or voltage applications, the open pore networks may be substantially filled with a conductive material. The energy chip may comprise an open network of pores that is substantially filled with a conductive material. In this variation, the conductive surface area of the energy chip is less than the surface area of the open network of pores as it existed in monolith before filling.

It should be noted that the conductive pathways formed by making the open pore network in sol-gel derived monoliths conductive are generally continuous conductive pathways, rather than conductive pathways that are formed from point-point contacts between discrete conductive particles. Therefore, the high internal resistance that can result from particle-particle contacts, e.g., carbon-carbon contacts, may not be present or dominant in the energy chips described here. Therefore, the energy chips may have overall lower internal resistance, lower ESR, and higher conductivity. Besides reducing power losses due to resistance between conductive particles, the increased conductivity may allow thicker energy chips to be made, which may increase surface area even more, and increase physical robustness of the energy chips.

Any suitable method or technique may be used to make the open pore network in the sol-gel derived monoliths conductive. For example, the pores may be partially filled with graphite, a graphite-like material, or a conducting carbon derived from the polymerization and carbonization of carbon precursor materials like but not limited to, furfural, furfuryl alcohol (2-furylmethanol), polyfurfuryl alcohol, resorcinol formaldehyde, sucrose, glucose, and melamine. For example, metal or conductive metal oxides may be deposited in the open pore network, e.g., by chemical vapor deposition techniques such as atomic layer deposition. In some situations, a colloidal solution containing a metal and/or conductive metal oxide may be impregnated into the porous network, the liquid of the colloidal solution removed, and the metal and/or metal oxide particles allowed to coalesce, e.g., by melting or rapid thermal processing.

As stated above, metal and/or metal oxide particles in an aqueous colloidal solution may be allowed to ingress into an open pore network in the monoliths used to make the energy chips described herein. The solvent may then be drawn off, leaving metal and/or conductive metal oxide particles lining the pores. Any technique may then be used to allow the metal and/or conductive metal oxide particles to coalesce to form a continuous conductive network. For example, the monolith may be subjected to rapid high temperature excursions to melt or coalesce the particles, similar to rapid thermal processing (RTP) that is used in the semiconductor industry. If desired, this process can be repeated to build up a conductive network. Any suitable metal and/or conductive metal oxide particles may be used build up a conductive network. RTP may be used in this instance to reduce the thermal budget and/or to prevent thermal equilibrium from reducing or restricting the ability of the conductive material to diffuse during thermal processing. During RTP, conductive particles may be subject to temperatures ranging from about 200° C. to about 1200° C. with ramp rates varying from about 20° C./sec to about 250° C./sec. Typical processing times for RTP are less than about 1 minute. In general, the particles may be nanoparticles having an outer dimension smaller than that of the nanopores present in the monolith. For example, gold nanoparticles may be deposited in the open pore network as described above, and then subjected to RTP conditions to form a continuous gold network threading its way through the monolith.

In still other variations, reaction precursors to conducting polymer films may be impregnated into a nanoporous monolith. Concentrations of the reaction precursors can be adjusted so as to coat the open pore network of the monolith with the precursor. In situ polymerization reaction conditions such as the presence of catalysts, pH, temperature profile, and reaction time, can be adjusted to result in a polymer coating on the open pore network. Following formation of a continuous polymer film threading its way through the open pore network, post reaction processing, e.g., carbonization, may be used to convert the polymer film into a conducting film on the open pore network or convert the polymer to fill. For example, as described above, furfuryl alcohol may be introduced and polymerized in the open network of pores of the silica sol-gel derived monolith. The sol-gel derived monolith can be fabricated as a thin free standing wafer. A 100% solution of furfuryl alcohol or solution of pure furfuryl alcohol with 0.1-0.5% of catalyst, such as p-toluenesulfonic acid (PTSA) or oxalic acid is then introduced into the pore network of the wafer at room temperature. The wafer containing the furfuryl alcohol is then heated between about 60 and about 150° C. for about 5 to about 25 hours to initiate polymerization. This process can be repeated several times to maximize pore impregnation by the furfural. The wafer containing the polymerized furfuryl alcohol is then removed to a furnace to be heat to a final temperature of between 600 and 1100° C. under an inert atmosphere to complete the carbonization process and generate a conducting carbon material. The template can then be removed partially or completely. In some cases, the wafer containing the polymerized furfuryl alcohol is removed at lower temperatures from between 300 and 600° C. and the template is removed partially or completely. The free standing or partially free standing polymerized furfuryl alcohol is returned to the furnace for additional thermal treatment to complete the carbonization process and generate a conducting carbon monolith. Additionally, in the case of monomers like furfuryl alcohol which polymerize in a linear chain, cross-linking agents can be added to the reaction mixture prior to heating to increase the connectivity of the polymer. For example, lysine 5% by weight can be used. Another example, as described above, resorcinol and formaldehyde in aqueous solution may be polymerized in situ in the open pore network of a silica sol-gel derived monolith, wherein small amounts of base may be added to catalyze the polymerization. Examples of suitable reaction conditions are provided in C. Lin and J. A. Ritter, Carbon 35 (1997) 1271, which has already been incorporated herein by reference in its entirety. In both the above examples, post-polymerization processing in the presence of an oxidizing gas, e.g., CO₂, at elevated temperature may be used to increase the density of the film formed from the polymer film. As the density of the film increases, the film becomes more graphite-like, leading to increasing conductivity with increasing density. Post-polymerization process in the presence of an oxidizing gas may be completed using processing times up to about 10 hours, and at processing temperatures in a range from about 200° C. to about 1200° C.

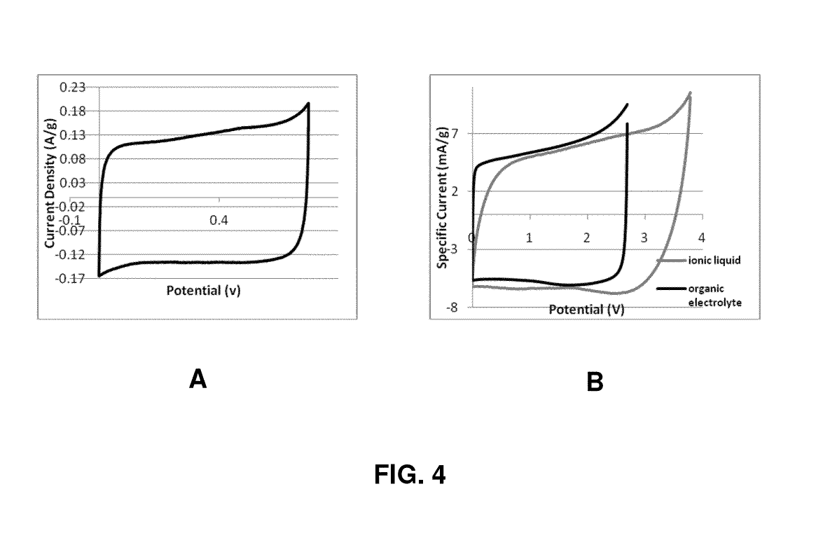

Additional variations of high surface area conductive energy chips are provided herein. These energy chips comprise a continuous skeletal framework formed of a conductive material that is formed using a sol-gel derived monolith as a template. Thus, these energy chips may be formed by substantially filling an open pore network with a conductive material, for example, as described and illustrated in connection with FIG. 4B of WO 2009/152239, entitled “Nanoporous Electrodes and Related Devices and Methods,” which is incorporated herein by reference in its entirety. After a three-dimensional conductive network is formed in the monolith, the sol-gel template may be selectively removed, or at least partially removed leaving behind a free-standing or substantially free-standing conductive framework. The sol-gel template may be removed using any suitable technique, e.g., by dissolving using a suitable solvent. For example, for silica sol-gel monoliths, 1%-48% hydrofluoric acid (HF) or 0.1 M-3 M KOH may be used to dissolve the monolith and leave behind a conductive framework. The dissolution temperatures will range near room temperature and may be controlled from about 20° C. to about 60° C. The dissolution concentrations of HF used can vary from about 1% to about 48% (e.g., from about 1% to about 30%) HF by weight. In some cases, it may be desired to leave behind a residual amount of the monolith to impart structural strength to the conducting framework. Another method used for template removal is the dissolution of the template using a 0.1 M to 5 M solution of KOH at 30° C. to 75° C. to dissolve the silica and leave a free standing or substantially free standing conductive framework in place. As with the other energy chip variations described herein, these free-standing high surface area energy chips may be used as electrodes in any device requiring high surface area electrodes, e.g., energy storage devices such as capacitors, e.g., ultracapacitors, batteries, and fuel cells.

As these energy chips are made using the open pore network of a sol-gel derived monolith as a template, their conductive surface may be similar to that of the template. However, since the conductive material has been used to fill the open pore network, the conductive surface area of the resulting free-standing energy chips may be lower or higher than that of the sol-gel template. These energy chips may have a conductive surface area that is about 500 m²/g to about 5000 m²/g, or even higher, e.g., at least about 500 m²/g, at least about 550 m²/g, at least about 600 m²/g, at least about 650 m²/g, at least about 700 m²/g, at least about 750 m²/g, at least about 800 m²/g, at least about 850 m²/g, at least about 900 m²/g, at least about 950 m²/g, at least about 1000 m²/g, at least about 1100 m²/g, at least about 1200 m²/g, at least about 1300 m²/g, at least about 1400 m²/g, at least about 1500 m²/g, at least about 1600 m²/g, at least about 1700 m²/g, at least about 1800 m²/g, at least about 1900 m²/g, at least about 2000 m²/g, at least about 2200 m²/g, at least about 2400 m²/g, at least about 2600 m²/g, at least about 2800 m²/g, at least about 3000 m²/g, at least about 3500 m²/g, at least about 4000 m²/g, at least about 4500 m²/g, or at least about 5000 m²/g. These energy chips may have an average pore size in a range from about 0.3 nm to about 300 nm, from about 0.3 nm to about 100 nm, from about 0.3 nm to about 30 nm, from about 0.3 nm to about 10 nm. In some variations, the energy chips have a pore size distribution wherein at least about 50% of the pores are within about 30% of an average pore size, within about 20% of an average pore size, or within about 10% of an average pore size.

The conductive material of the energy chips may have a porosity of about 30% to about 90% by volume, e.g., about 30% to about 90%, about 40% to about 90%, or about 45% to about 75%. In some variations, the porosity may be lower than about 30% by volume or higher than about 90% by volume, e.g., up to about 95% by volume.

The energy chips may have any suitable thickness. Factors that may be considered in selecting an electrode thickness include an electrode porosity, a device voltage rating, a surface area of an electrode, a composition of an electrode, and a conductivity of an electrode. In some cases, an energy chip thickness may be about 300 microns or less, about 150 microns or less, about 120 microns or less, about 100 microns or less, or about 80 microns or less. The thickness of an energy chip or electrode may be measured by methods known in the art, such as using a digital caliper by Mitutoyo Corp. (Code:500-193 Model No: CD-12″ CP). The thickness of an energy chip may be an average (e.g., a median, mean, and/or mode) of the thickness values measured at different portions of the energy chip.

The energy chip or monolithic electrode provided herein may be stacked in multiple layers in an energy storage device. Thus, each energy chip may have a substantially uniform thickness across different parts of the chip, each chip may be substantially flat, and/or the surface roughness of each chip may be such that when multiple chips are stacked in an energy storage device (such as in a battery) the neighboring chips can be placed closely but without touching each other directly.

In some embodiments, the energy chip has a substantially uniform thickness across different parts of the electrode. For example, the thickness of a chip across different portions of the chip may vary by less than 10%, less than 9%, less than 8%, less than 7%, less than 6%, less than 5%, less than 4%, less than 3%, less than 2%, or less than 1% of the thickness of the chip.

The flatness of the electrode may be measured using methods known in the art, for example, using technology as applied for silicon wafers (e.g. using a Nanovea 750 system) (http://nanovea.com/Application%20Notes/WaferFlatness.pdf). Flatness may be quantified by laying the chip on a flat platform, which serves as reference plane for the measurement. The height difference between the top surface of the chip and the reference plane at various points are measured. In some embodiments, the chip is substantially flat across the entire chip. For example, the peak-to-reference flatness deviation among the whole electrodes is less than 10%, less than 9%, less than 8%, less than 7%, less than 6%, less than 5%, less than 4%, less than 3%, less than 2%, or less than 1% of the thickness of the chip.

The roughness parameter is also important for flat chips because it determines how small the gap between two electrodes could be without having any short circuit. Surface roughness of the chip may be characterized by the fluctuation in height of the chip's surface. Surface roughness can be measured by methods known in the art, such as by using a Zeta-20 instrument (http://www.zeta-inst.com/page/zeta-20-summary). In some embodiments, the peak-to-valley roughness of a chip is less than 10%, less than 9%, less than 8%, less than 7%, less than 6%, less than 5%, less than 4%, less than 3%, less than 2%, or less than 1% of the thickness of the chip. For example, the Peak-to-Valley roughness of a 100 μm thick electrode was measured to be 1.5 μm (1.5% of the thickness).

The energy chips described herein made of carbon material may has a resistivity from about 0.001 Ω-cm to about 5 Ω-cm, such as from about 0.001 Ω-cm to about 1 Ω-cm, about 0.001 Ω-cm to about 0.5 Ω-cm, about 0.001 Ω-cm to about 0.1 Ω-cm, about 0.001 Ω-cm to about 0.05 Ω-cm, about 0.001 Ω-cm to about 0.01 Ω-cm, about 0.001 Ω-cm to about 0.005 Ω-cm, about 0.01 Ω-cm to about 5 Ω-cm, about 0.01 Ω-cm to about 1 Ω-cm, or about 0.01 Ω-cm to about 0.1 Ω-cm.

### II. Energy Storage Devices

Energy storage devices are described herein. In general, the devices comprise a cell that has first and second energy chips as electrodes across which a potential may be applied. An electrolyte is provided in the cell between the first and second electrodes. A separator is provided in the electrolyte to prevent the cell from shorting. For example, if the device is a capacitor, an ultracapacitor or battery, the separator is insulating and permeable to ions of the electrolyte so that ions can diffuse to the electrodes to build up the electric double layers at the electrode surfaces, but does not allow substantial current to flow in the electrolyte between the electrodes. If the device is a fuel cell, the separator may comprise a proton exchange membrane. Any energy chips described herein may be used as the first and/or the second electrode in the energy storage device. In some variations of the devices, the first conductive network may remain in the monolith in the first electrode, as described above. In other variations, the first conductive network may be a stand-alone or substantially stand-alone conductive network. These electrodes are described above, and are formed by selectively removing the monolith template after filling an open pore network of the monolith with a conductive material to form the first conductive network.

Any of the high surface area energy chips derived from a nanoporous sol-gel derived monolith as described herein may be used in the devices. Further, the first electrode and the second electrode may be the same or different. For example, if the energy storage device is a capacitor, both electrodes may be high surface area electrodes formed from sol-gel derived monoliths as described herein. In other variations, the first and second electrodes may be different. For example, if the energy storage device is a battery, an anode may be a high surface area electrode formed from sol-gel derived nanoporous electrode that comprises a reactive species.

In the energy storage devices, an average pore size and/or a pore size distribution may be selected to accommodate an ionic species of the electrolyte. For example, in an ultracapacitor, an ion of the electrolyte must be able to access the pores of a high surface area electrode as described herein to take advantage of that surface area. If the topography of the conductive surface contains features of a scale too small to accommodate the ionic species of the electrolyte, the effective conductive surface area is reduced. For example, a substantial fraction of the pores in an electrode may have a dimension of about 1 nm to about 2 nm. Further, in some cases, the pore sizes may be adjusted to be generally smaller than a solvation shell of an ionic species in the electrolyte. This may allow the ionic species to move even closer to an electrode surface. Creating a broad distribution of pore sizes may lead to underutilized volume in the electrodes due to relatively low surface area sections and underutilized surface area in the electrodes due to pore sizes that are too small to accommodate an ionic species. Thus, an electrode may have its pore size finely tuned as described herein to increase electrolyte-electrode interactions, and to increase effective utilization of the conductive surface area of the electrodes. In some instances, the electrodes may be customized or selected for use with particular electrolytes.

In some variations, the energy storage device may be an ultracapacitor as described and illustrated in connection with FIG. 6A of WO 2009/152239, entitled “Nanoporous Electrodes and Related Devices and Methods”. The ultracapacitor may comprise a first nanoporous energy chip as an electrode and a second nanoporous energy chip as an electrode separated by an insulating separator. Current spreading plates are placed in electrical contact with the nanoporous energy chips. An electrolyte is present between the first and second energy chips and ionic species of the electrolyte interpenetrates the nanopores in each of the chips. When a potential (e.g., from a battery) is applied between the two electrodes via electrical leads, ions of the electrolyte migrate to the electrode having the opposite charge, including through the separator that is permeable to ions of the electrolyte, to store charge. The ultracapacitor may be sealed in a container. Any suitable type of container now known or later developed may be used, e.g., a barrel-shaped can, or a flat coin-shaped can.

The current spreading plates may be formed of any metal, and have any thickness selected to withstand the voltage and or current levels to which the ultracapacitor will be exposed. For example, in variations, the current spreading plates may comprise copper, nickel, or aluminum.

The electrodes may comprise any of the high surface area nanoporous energy chips described herein. Other variations are contemplated in which only one of the electrodes is a nanoporous energy chip, and the other electrode is a standard electrode, e.g., a carbon-based electrode. As described above, the nanoporous energy chips may have an average pore size and pore size distribution selected to allow ingress of an ionic species of electrolyte into the pores, so that the ion can take advantage of the high surface area. In addition, also as described above, the size of the pores may be finely tuned so as to be sized smaller than a solvation sphere of the ionic species to allow that ion to approach even closer to the conductive electrode surface.

As stated above, the electrodes in an ultracapacitor may be the same or different. In some cases, the electrodes described herein may be used in asymmetric ultracapacitors, i.e., a capacitor in which one electrode comprises a capacitive material that stores charge electrostatically, and one electrode that comprises a material that stores charge via a fast, reversible faradaic process (electron transfer) at a certain electrode potential. Non-limiting examples of capacitive materials include carbonaceous materials, conducting metals and metalloids, and conducting metal oxides. Non-limiting examples of materials that lend themselves to faradaic charge storage include inorganic oxides, sulfides, or nitrides such as oxides, sulfides or nitrides of molybdenum and tungsten, ruthenium oxide, manganese dioxide, iron sulfide, silver oxide, nickel oxyhydroxide, and conducting polymers such as polythiophenes (e.g., poly(3-methylthiophene). Thus, in an asymmetric ultracapacitor, the anode may comprise a capacitive material that has a capacity for electrostatic charge storage, and the cathode may comprise a material that has high faradaic charge storage capacity.

In an asymmetric ultracapacitor, the anode and/or the cathode may be formed from a nanoporous sol-gel monolith as described herein. For example, the cathode of an asymmetric ultracapacitor may be derived from a sol-gel monolith in which the open pore network has been filled with a conductive material. As described above, the sol-gel monolith may remain as a support for the electrode, or may function as a template that is substantially removed to result in a high surface area conductive framework that had been formed within the open pore network. The anode of an asymmetric ultracapacitor may be derived from a sol-gel monolith in which the open pore network has been filled with a conductive material that lends itself to faradaic charge storage as described above. Here again, the sol-gel monolith may remain as a support for the anode, or may function as a template that is substantially removed to result in a high surface area conductive framework that had been formed within the open pore network. In some variations of asymmetric ultracapacitors, a sol-gel derived cathode may be used in combination with another type of anode, and a sol-gel derived anode may be used in combination with another type of cathode. Non-limiting examples of alternative cathodes and anodes that may be used in any combination with any of the sol-gel derived electrodes are for example described in U.S. Pat. No. 7,199,997, and A. Balducci et al., Applied Physics A 82 (2006), 627-632, each of which is incorporated herein by reference in its entirety.

An exemplary asymmetric ultracapacitor is described and illustrated in connection with FIG. 6B of WO 2009/152239, entitled “Nanoporous Electrodes and Related Devices and Methods”. The asymmetric ultracapacitor may comprise current spreading plates, an anode in electrical contact with the current spreading plate, and a cathode in electrical contact with the current spreading plate. The anode may comprise a material that has high faradaic charge storage capacity, and the cathode may comprise a capacitive material that has high electrostatic storage capacity. An insulating separator that is porous to the electrolyte is disposed between the anode and cathode. The anode and/or the cathode may be nanoporous electrodes derived from sol-gel monoliths as disclosed herein. The asymmetric ultracapacitor may be sealed in a container. Any suitable type of container now known or later developed may be used, e.g., a barrel-shaped can, or a flat coin-shaped can.

The electrolyte used in the ultracapacitors (symmetric or asymmetric) may be any suitable electrolyte described herein, otherwise known, or later discovered. For example, the electrolyte may be organic or inorganic. The electrolyte may be selected based on a voltage rating of the ultracapacitor. Organic electrolytes may be selected for ultracapacitors designed to have a voltage rating of about 1.5V to about 3V, or from about 2V to about 3V. Such organic electrolytes may have dielectric constant of about 40. An ionic liquid may be used for devices designed to have a higher voltage rating, e.g., about 5V to about 6V, or about 5V to about 7V. The dielectric constant of ionic liquid electrolytes may be about 30. For low voltage ratings, e.g., voltage ratings below about 2.5V or about 3V, an aqueous electrolyte may be used. Such aqueous electrolytes may have a dielectric constant of about 10.

Non-limiting examples of suitable organic electrolytes include carbonates such as propylene carbonate, ethylene carbonate, butylene carbonate, dimethyl carbonate, diethyl carbonate, dipropyl carbonate, methyl ethyl carbonate, methyl butyl carbonate, methyl propyl carbonate, ethyl propyl carbonate, butyl propyl carbonate, 1,2-butylene carbonate, 2,3-butylene carbonate, 1,2-pentene carbonate, 2,3-pentene carbonate; nitriles such as acetonitrile, acrylonitrile, propionitrile; sulfoxides such as dimethyl sulfoxide, diethyl sulfoxide, ethyl methyl sulfoxide, benzyl methyl sulfoxide; amides such as formamide, dimethyl formamide; pyrrolidones such as N-methylpyrrolidone; esters such as p-butyrolactone, γ-butyrolactone, 7-valerolactone, β-valerolactone, γ-butyrolactone, 2-methyl-γ-butyrolactone, acetyl-γbutyrolactone, phosphate triesters; and ethers such as 1,2-dimethoxyethane, 1,2-ethoxyethane, diethoxyethane, methoxyethoxyethane, dibutoxyethane, nitromethane, dimethoxypropane, diethyoxypropane, methoxyethoxypropane, tetrahydrofuran, 2-methyl-tetrahydrofuran, alkyltetrahydrofurans, dialkyltetrahydrofurans, alkoxytetrahydrofurans, dialkoxytetrahydrofurans, 2-methyltetrahydrofuran, 1,2-dioxolane, 1,3-dioxolane, 1,4-dioxolane, 2-methyldioxolane, 4-methyl-dioxolane, alkyl-1,3-dioxolanes, sulfolane, 3-methylsulfolane, diethyl ether, diethylene glycol dialkyl ethers, diethylene glycol dialkyl ethers, triethylene glycol dialkyl ethers, tetraethylene glycol dialkyl ethers, alkylpropionates, dialkyl malonates, alkyl acetates, methyl formate, methyl acetate, methyl propionate, ethyl propionate, and maleic anhydride.

In some variations of the ultracapacitors, e.g., asymmetric ultracapacitors, solvent-free ionic liquids may be used as electrolytes, e.g., 1-butyl-3-methyl-imidazolium tetrafluoroborate, 1-butyl-3-methyl-imidazolium hexafluorophosphate, N-butyl-N-methylpyrrolidinium bis(trifluoromethanesulfonyl)imide, 1-ethyl-3-methylimidazoliumtris(pentafluoroethyl)trifluorophosphate, and 1-butyl-1-methylpyrrolidinium bis(trifluoromethylsulfonyl)imide.

The separator used in the ultracapacitors (symmetric or asymmetric) may be any suitable separator, and as described above, is electrically insulating and permeable to ions of the electrolyte so that the ions can migrate to the electrodes, but prevent shorting of the capacitor. Non-limiting examples of separators include thin paper films, or Celgard™ separator films. In some variations, a sol-gel derived separator may be used, where the sol-gel derived separator is designed to have an appropriate permeability for ions in the electrolyte.

Various combinations of specific powers (W/kg) and specific energy (W-h/kg) may be achieved with the ultracapacitors (symmetric or asymmetric), for example, as described and illustrated in connection with FIG. 7 of WO 2009/152239, entitled “Nanoporous Electrodes and Related Devices and Methods”. Specific powers greater than 10 kW/kg, and specific energies of about 5 Wh/kg to about 100 Wh/kg are ranges of specific powers and specific energies that may be delivered with the ultracapacitors described here. Thus, some of the ultracapacitors may have a specific energy of at least about 10 Wh/kg, at least about 20 Wh/kg, at least about 30 Wh/kg, at least about 40 Wh/kg, or at least about 50 Wh/kg. Ultracapacitors described here may have a specific power of about 10 kW/kg or higher, e.g., about 10 kW/kg, about 20 kW/kg, about 30 kW/kg, about 40 kW/kg, or about 50 kW/kg, or even higher.

Ultracapacitors (symmetric or asymmetric) as described herein may be capable of many charge/discharge cycles, e.g., greater than about 3×10⁵ cycles. Further, the ultracapacitors may have very high charge and discharge efficiencies, e.g., about 90% or greater, about 95% or greater, about 98% or greater, about 99% or greater, about 99.5% or greater, about 99.8% or greater, about 99.9% or greater, or very close to 100%.

In an ultracapacitor described herein where the conductive material in the electrode is made of conductive carbon from any source, the capacitance of the carbon material may be in a range from about 100 F/g to about 700 F/g. In an ultracapacitor device described herein, the capacitance may be in the range of about 100 F/g to about 200 F/g, about 300 F/g to about 400 F/g, or about 400 F/g to about 500 F/g for electrodes made with conductive carbon. In an asymmetric ultracapacitor device described herein, the capacitance may be in the range about 100 F/g to about 250 F/g.

Ultracapacitors (asymmetric or symmetric) having alternate electrode configurations are possible. For example, the electrodes described herein may form a portion of an interdigitated electrode assembly. Such an interdigitated electrode assembly may be used to increase an energy storage capacity or voltage rating of an ultracapacitor. An exemplary ultracapacitor, for example, as described and illustrated in connection with FIG. 8 of WO 2009/152239, entitled “Nanoporous Electrodes and Related Devices and Methods,” may comprise a first electrode assembly, and a second electrode assembly. A potential may be placed between the first and second electrode assemblies with electrical leads. The first electrode assembly comprises a first metal or metallized current spreading plate with which electrical lead makes electrical contact, and the second electrode assembly comprises a second metal or metallized current spreading plate with which electrical lead makes electrical contact. Extending generally perpendicularly from first current spreading plate of the first electrode assembly is a series of spaced-apart electrodes. Any one or any combination of the electrodes may comprise a high surface area electrode as described herein. For example, any single one, any subset, or all of the electrodes may comprise a high surface area silica sol-gel derived electrode having a thickness of about 100 microns. Similarly, extending perpendicularly from the second current spreading plate of the second electrode assembly is a series of spaced-apart electrodes. Here again, any single electrode, any subset of the electrodes, or all of the electrodes may comprise a high surface area electrode as described herein. Any one of the electrodes may comprise a high surface area silica sol-gel derived electrode having a thickness of about 100 microns. The electrodes may be interdigitated. Separating the electrodes are separators. An electrolyte is dispersed in the cell in the volume between the electrode assemblies, filling the volume between the interdigitated electrodes. The electrolyte may be any electrolyte described herein, otherwise known or later developed. The separators are porous to ionic species in the electrolyte, and may be any separators described herein, otherwise known, or later developed.

Electric double layer capacitors (EDLCs) have applications in a variety of technology areas which require energy storage and energy delivery rapidly and repetitively with relatively high power. For example, EDLC may be used in the automobile sector like hybrid-electric vehicles of various types where the EDLC could be used to augment the vehicle battery, leveling the load on the battery by powering acceleration and recovering energy during braking, thereby increasing battery life and reducing battery size and weight. Another general application area would be in the motion capture of energy that would otherwise be wasted; for example, the capture of energy in the repetitious up and down movement of heavy shipping containers (Miller and Burke The Electrohemical Society Interface Spring 2008, 53-57). Additionally, applications could be found for bulk energy storage by electric utilities by storing off-peak electricity at night for use during the day or other grid applications like load leveling solar and wind electric generating farms. Many additional applications could be found in consumer electronics and power tools.

### III. Systems

Energy storage systems are also provided here. These systems comprise multiple energy storage cells, at least some of which may be connected in series or in parallel. In these systems, each energy storage cell comprises two electrodes configured to be oppositely charged and an electrolyte disposed between the two electrodes. At least one electrode in at least one of the cells comprises an energy chip as described herein. Such multiple cell energy storage systems may be used in applications requiring increased energy storage capacity and/or increased voltage ratings.

An exemplary energy storage system, for example, as described and illustrated in connection with FIG. 9A of WO 2009/152239, entitled “Nanoporous Electrodes and Related Devices and Methods,” comprises multiple energy storage cells connected in series. An external potential is applied across the series arrangement using electrical leads. Each cell comprises an ultracapacitor (symmetric or asymmetric). At least one of cells may comprise an ultracapacitor similar to that described and illustrated in connection with FIG. 6A or 6B of WO 2009/152239, entitled “Nanoporous Electrodes and Related Devices and Methods”. Thus, each cell comprises a first electrode and an opposite polarity second electrode, and a separator that is permeable to ionic species in an electrolyte that is present in each cell. Each positive polarity electrode of a cell is connected to a negative polarity electrode of an adjacent cell so that the cells are arranged in electrical series. The entire system may be sealed in any suitable container, e.g., in a housing or barrel shaped can, or a lower profile relatively flat container.

Another exemplary system for example, as described and illustrated in connection with FIG. 9B of WO 2009/152239, entitled “Nanoporous Electrodes and Related Devices and Methods,” comprises multiple energy storage cells connected in series. An external potential is applied across the entire series, using electrical leads. Each cell comprises an ultracapacitor (symmetric or asymmetric). At least one of the cells may comprise an ultracapacitor similar to that described and illustrated in connection with FIG. 6A or 6B of WO 2009/152239, entitled “Nanoporous Electrodes and Related Devices and Methods”. Thus each cell comprises a first electrode and an opposite polarity second electrode. Separating the first and second electrodes is a separator that is permeable to ionic species in the electrolyte that is present in each cell. Each positive polarity electrode of a cell is connected to a negative polarity electrode of an adjacent cell so that the cells are arranged in electrical series. In this particular variation, adjacent electrodes are configured as bipolar electrode structures, where electrodes of opposite polarity are separated by electrolyte and a solid layer that is nonporous to the electrolyte. Opposite polarity electrodes may be arranged in an interdigitated manner relative to each other. The entire system may be sealed in any suitable container, e.g., a box or barrel shaped can, or a lower profile flatter container.

For energy storage systems comprising series-connected cells, such as those described and illustrated in connection with FIG. 9A or 9B of WO 2009/152239, entitled “Nanoporous Electrodes and Related Devices and Methods,” the electrodes used may be any electrodes described herein. At least one of the electrodes in the system, which may be either a positive electrode or a negative electrode, is derived from a sol-gel as described herein.

Another exemplary energy storage system, for example, as described and illustrated in connection with FIG. 10 of WO 2009/152239, entitled “Nanoporous Electrodes and Related Devices and Methods,” comprises multiple energy storage cells connected in parallel. An external potential is applied across the parallel arrangement using electrical leads. Any one of or all of the cells may comprise an ultracapacitor similar to that described and illustrated in connection with FIG. 6A or 6B of WO 2009/152239, entitled “Nanoporous Electrodes and Related Devices and Methods”. Thus, each cell comprises a first electrode and an opposite polarity second electrode. Separating the first and second electrodes is an insulating separator that is permeable to ionic species in the electrolyte that is present in each cell. Each positive polarity electrode of a cell is connected to the positive polarity electrodes of other cells in the circuit, and each negative polarity electrode of a cell is connected to the negative polarity electrodes of other cells in the circuit so that the cells are connected in parallel. At least one of the electrodes in the in one of the cells in system is a high surface area electrode derived from a sol-gel as described herein.

The ultracapacitors described herein may be used in a variety of applications. For example, they may be used to replace batteries in certain applications, e.g., for handheld electronic applications. In other situations, they may provide backup power for electronic devices, e.g., for computers. The ultracapacitors may be used in combination, e.g., in a parallel circuit, with a battery to augment peak power delivery of that battery. The ultracapacitors may be used as energy storage devices in a hybrid-electric engine such as a hybrid-electric engine used to power vehicles.

### IV. General Methods for Measurement of Capacitance and ESR

Capacitance and resistance measurement is obtained by Princeton Applied Research's VerssaSTAT 3 Potentiostat and Maccor 4 Channel Material and Cell Test system, model 4304.

### Single Electrode Measurement

A 3-electrode electrochemical cell with VerSTAT 3 potentiostat is used to perform single electrode measurement. Ag/AgCl NaCl (1 M) electrode and a platinum wire are used as the reference electrode and counter electrode respectively.

Capacitance of single electrode is measured from cyclic voltammetry and constant current charge/discharge test in 5M H₂SO₄. ESR is obtained in the constant current charge/discharge test.

### Cyclic Voltammetry

Linear potential charging and discharge at a scan rate of 1 mV/s-10 mV/s is applied to the nanoporous electrode within a potential range that falls within the decomposition voltage of the electrolyte. FIGS. 4-A and 4-B depict typical cyclic voltammograms at a scan rate of 1 mV/s.

Capacitance is measured using integral and differential method. In the integral method, the total charge difference is integrated throughout the discharge and charge process and the capacitance value is obtained by the following equation, as described in equation 2 in P. KURZWEIL1, M. CHWISTEK, “Electrochemical and Spectroscopic Studies on Rated Capacitance and Aging Mechanisms of Supercapacitors”, 2nd European Symposium on Super Capacitors & Applications (ESSCAP), Lausanne, published 2-3 Nov. 2006 (Kurzweil's paper).

$$\begin{matrix}C = \frac{1}{{U}_{0} - {U}_{t}} {\int }_{0}^{t} I ( t ) d {t}^{′} \\ = \frac{Δ Q}{2 \times Δ V \times m} [ F \text{/} g carbon ]\end{matrix} \qquad ( 1 )$$

ΔQ is the total difference in the state of charge (in Coulomb) during charging and discharging, ΔV is the potential window in the process (0.7−0=0.7V) and m is the mass of the carbon electrode.

In the differential method, constant capacitance region at 0.3V and 0.5V is used to calculate the capacitance by the following equation:

$$C = \frac{I}{\frac{d V}{d t} \times m} [ F \text{/} g carbon ] \qquad ( 2 )$$

I is the discharging current (in Ampere) at potential of 0.3 and 0.5 V,

$$\frac{d V}{d t}$$

is the scan rate in

$$\frac{V}{s}$$

, m is mass of electrode.

The capacitance obtained by the methods above could also be expressed per surface area of the carbon electrode as:

$${C}_{per surface} = \frac{C [ F \text{/} g ] \times 100}{Specific Surfacce Area [ {m}^{2} \text{/} g ]} [ µ F \text{/} {cm}^{2} ] \qquad ( 3 )$$

### Constant Current Charge/Discharge

Constant current (positive and negative) is applied to charge and discharge the electrode. Current of |5 mA/F| is typically used. Capacitance is calculated at the linear region in the discharge curve using equation (4), which also describes in equation (1) in Kurzweil's paper.

$$C = \frac{I}{( d V / d t ) \times m} [ F \text{/} g carbon ] \qquad ( 4 )$$

I is the discharge current in ampere, while (dv/dt) is the average slope of the discharge curve from 80% to 40% of the maximum voltage of the test.

The ESR (Equivalent Series Resistance) could be identified by the initial voltage drop during the discharge period. ESR is calculated from equation (5), which is described in equation 1 from Kurzweil's paper.

$$ESR = \frac{Δ V}{( • \vert {I}_{charge} \vert + \vert {I}_{discharge} \vert )} [ Ω ] \qquad ( 5 )$$

### Device Measurement

Two energy chips with weight difference less than 10% are used to construct a supercapacitor device/cell. Maccor's 4 Channels Material and Cell Test System model 4304 is used to measure the capacitance and ESR with the same procedures as the single electrode measurement.

The following Example is provided to illustrate but not limit the various embodiments.

### Example 1

### Process for Preparing a Monolithic Carbon Electrode Chip Using a Nanoporous Monolith as a Template

The template used to form the monolithic carbon electrode material was made from a thin sol-gel wafer. The wafer was fabricated by casting a silica sol-gel solution into a mold as described in U.S. patent application Ser. No. 61/638,404 entitled “Methods and Apparatus for Casting Sol-Gel Wafers” (Attorney Docket Number 64334-30003.01). The chemical composition and molar ratio of the components of the sol-gel solution were 1 TEOS (tetraethyl orthosilicate), 2.25 H₂O (water), 0.075 HF (hydrofluoric acid) and 0.01HCl (hydrochloric acid). These chemicals were then mixed, cast into a mold and left sitting at room temperature for up to 3 hours. The sample (sol-gel plus mold) was then placed in an incubator at 33° C. to age for up to 72 hours. The sample was then removed to an oven and baked at 160° C. under nitrogen for up to 24 hours (the ramp to 160° C. was done in air and the nitrogen turned on at 160° C.). After the drying step at 160° C. the sample was then sintered in a furnace at 720° C. for 2 hours in air. The resulting silica wafer had a surface area of 752 m²/g with an average pore diameter of 2.58 nm; and 55.6% of the pores in the resulting silica wafer were within 10% of the average pore diameter of 2.58 nm. A wafer having a thickness of 100 microns and a diameter of 25 mm was generated.

The first step in the formation of a monolithic carbon energy chip material was to take the silica sol-gel derived wafer having a thickness of 100 micron and a diameter of 25 mm and impregnate it with furfuryl alcohol. This was accomplished by placing the wafer in a shallow container that was filled with enough furfuryl alcohol to cover the wafer and allowing it to soak for up to five hours. The furfuryl alcohol saturated wafer was then removed from the container and excess furfuryl alcohol was cleaned from the surface of the wafer. The furfuryl alcohol saturated wafer was then heated at 60° C. to 150° C. in air for 30 hours to create polyfurfuryl alcohol throughout the porous silica network of the wafer. This composite material was then heated under nitrogen at 850° C. for five hours.

The sample was cooled to room temperature. The composite wafer was then soaked in concentrated HF and sonicated for one hour to remove the silica template leaving a monolith carbon chip in its place. The carbon monolith was heated to 1000° C. for 3 hours in a 5% CO₂, 95% N₂ atmosphere. The sample was then cooled to room temperature. The resulting material was tested for surface area, resistivity, and capacitance. This material had a measured BET surface area of 700 m²/g and average pore diameter of 9 nm; and 46.4% of the pores were within 30% of the average pore diameter of 9 nm. The resistivity of the material was 5 Ω-cm and had a measured capacitance of 50 F/g.

In an alternative experiment, the composite wafer after cooled to room temperature was then refluxed with 0.1 M KOH solution for 2 hours to partially remove the silica template. The KOH treated composite wafer was subsequently heated to 1200° C. for 3 hours. The composite wafer was then soaked in concentrated HF and sonicated for two hour to remove the silica template leaving a monolith carbon chip in its place. Then the carbon monolith was heated to 1000° C. for 1 hours in a 10% CO₂, 90% N₂ atmosphere. The sample was then cooled to room temperature. The resulting material was tested for surface area, resistivity, and capacitance. This material had a measured BET surface area of 2094 m²/g and average pore diameter of 9.4 nm; and 42% of the pores were within 30% of the average pore diameter of 9 nm. The resistivity of the material was 5 Ω-cm and had a measured capacitance of 160 F/g.

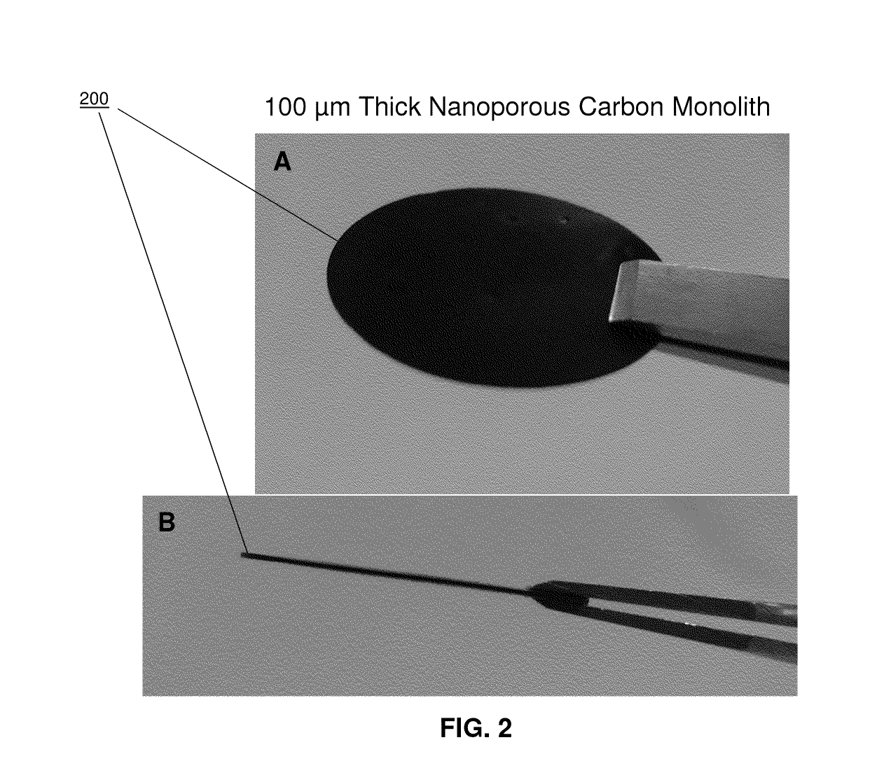

FIG. 2 illustrates energy chip 200 having a thickness of 100 microns that was produced using the method described above. The side view in FIG. 2-B demonstrate the flatness of the exemplary electrode of 100 micron in thickness.

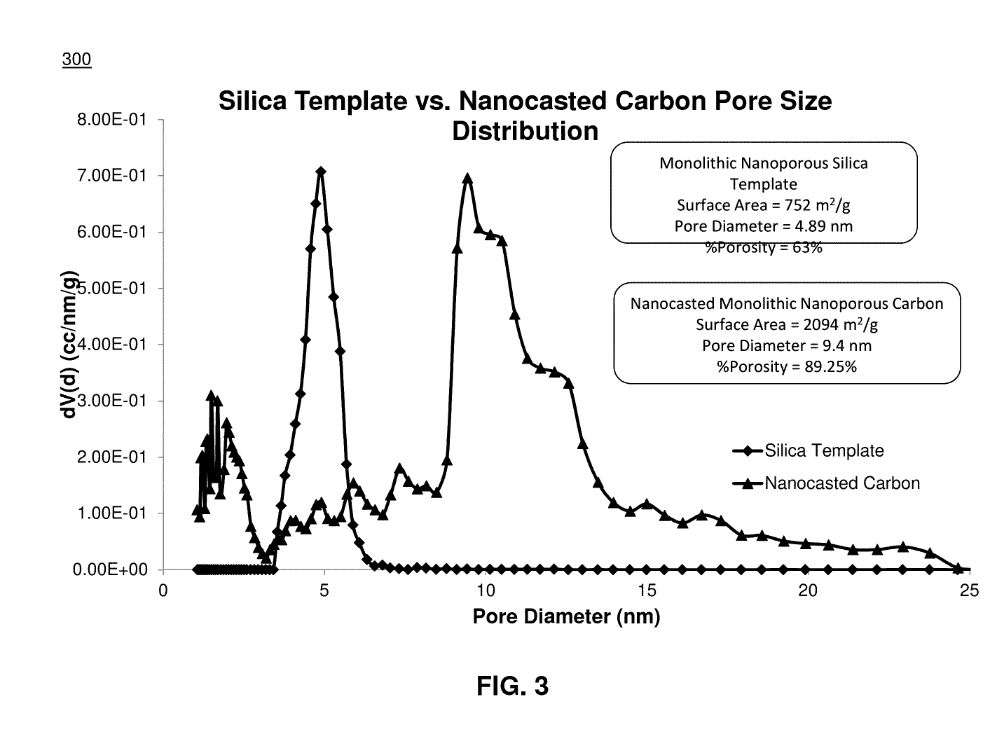

FIG. 3 illustrates pore size distribution of the silica template used in an experiment following the same process as described above to make the carbon energy chip and pore size distribution of the imaged carbon energy chip.

This disclosure is illustrative and not limiting. Further modifications will be apparent to one skilled in the art in light of this disclosure and such modifications are intended to fall within the scope of the appended claims. Each publication and patent application cited in the specification is incorporated herein by reference in its entirety as if each individual publication or patent application were specifically and individually put forth herein.

What is claimed is:

1. A nanoporous energy chip for use in an energy storage device, said chip comprising a conductive material, wherein the conductive material is monolithic and comprises an open network of pores having an average pore diameter between about 0.3 nm and about 30 nm, and wherein the conductive material forms a thin chip having a thickness of about 300 microns or less, and wherein the thickness across different portions of the chip varies by less than 10% of the thickness of the chip.

2. The energy chip of claim 1, wherein at least one of an average pore size and a pore size distribution in the open pore network is selected based on an ionic species of an electrolyte used in the energy storage device.

3. The energy chip of claim 1, wherein the conductive material comprises graphite, a graphite-like material, graphene, a graphene-like material, or carbon.

4. The energy chip of claim 1, wherein the conductive material comprises carbon derived from the polymerization and carbonization of one or more carbon precursor materials selected from the group consisting of furfural, furfuryl alcohol, polyfurfuryl alcohol, resorcinol formaldehyde, sucrose, glucose and melamine.

5. The energy chip of claim 1, wherein the conductive material comprises a metal, metal oxide, metal sulfide, or metal nitride selected from the group consisting of platinum, nickel, gold, palladium, molybdenum, tin oxide, indium tin oxide, zinc oxide, aluminum doped zinc oxide, vanadium pentoxide, titanium dioxide, molybdenum oxide, ruthenium oxide, molybdenum sulfide, tungsten oxide, tungsten sulfide, tungsten nitride, manganese dioxide, iron sulfide, lithium iron disulfide, lithium iron phosphate, lithium iron fluorine phosphate, zinc carbon, zinc chloride, lithium ion, lithium manganese spinel, lithium nickel manganese cobalt, lithium air, 5% vanadium-doped lithium iron phosphate olivine, metal hydrides, silver zinc, lead, nickel cadmium, nickel metal hydride, nickel zinc, silver oxide, nickel oxyhydroxide, molybdenum nitride and combinations thereof.

6. The energy chip of claim 1, wherein the conductive material has an average pore diameter between about 0.3 nm and about 15 nm.

7. The energy chip of claim 1, wherein the conductive material has a pore size distribution wherein at least about 50% of pores are within about 30% of an average pore size.

8. The energy chip of claim 1, wherein the conductive material comprises a pore size distribution wherein at least about 50% of pores are within about 20% of an average pore size.

9. The energy chip of claim 1, comprising a conductive surface area of at least about 2000 m²/g.

10. The energy chip of claim 1, configured for use in a capacitor, an electric double layer capacitor, a battery, or a fuel cell.

11. The energy chip of claim 1, wherein the thickness across different portions of the chip varies by less than 5%.

12. The energy chip of claim 1 further comprising an electrolyte in the open network of pores.

13. A method of making an energy chip, the method comprising:
a) providing a sol-gel derived silica monolith comprising an open network of pores, wherein the sol-gel derived silica monolith has a thickness of about 300 microns or less and comprises an open network of pores having an average pore diameter between about 0.3 nm and about 30 nm, and the thickness of the sol-gel derived silica monolith across different portions of the monolith varies by less than 10% of the thickness of the chip;
b) at least partially filling the open network of pores with a conductive material; and
c) selectively removing the silica material in the monolith to provide a conductive network which forms the energy chip.

14. The method of claim 13, wherein the open network of pores are substantially filled with the conductive material.

15. The method of claim 13, wherein at least partially filling the open network of pores comprises impregnating the open network of pores with a colloidal solution of metal and/or metal oxide particles.

16. The method of claim 13, wherein at least partially filling the open network of pores comprises impregnating the open network of pores with one or more precursors to a conducting polymer, and reacting the one or more precursors to form the conductive network.

17. The method of claim 16, wherein at least partially filling the open network of pores comprises impregnating the open network of pores with one or more carbon precursor materials selected from the group consisting of furfural, furfuryl alcohol, polyfurfuryl alcohol, resorcinol formaldehyde, sucrose, glucose and melamine, and converting the one or more carbon precursor materials into carbon by polymerization and carbonization.

18. The method of claim 13, adapted for making a conductive network having a conductive surface area of at least about 2000 m²/g.

19. The method of claim 13, wherein the sol-gel derived silica monolith has an average pore diameter between about 0.3 nm and about 10 nm.

20. The method of claim 13, wherein the sol-gel derived silica monolith has a pore size distribution wherein at least about 50% of pores are within about 30% of an average pore size.

21. The method of claim 13, wherein the sol-gel derived silica monolith has a pore size distribution wherein at least about 50% of pores are within about 20% of an average pore size.

22. The method of claim 13, wherein the thickness across different portions of the chip varies by less than 5% of the thickness.

23. An energy chip made by the method of claim 13.

24. The energy chip of claim 23, configured for use in a capacitor, an electric double layer capacitor, a battery, or a fuel cell.

25. An energy storage device comprising:
first and second energy chips as electrodes, wherein at least one of the energy chips comprises a conductive material, wherein the conductive material is monolithic and comprises an open network of pores having an average pore diameter between about 0.3 nm and about 30 nm, and the conductive material forms a thin chip having a thickness of about 300 microns or less, and wherein the thickness across different portions of the chip varies by less than 10% of the thickness;
an electrolyte disposed between the first and second energy chips; and
a separator disposed between the first and second energy chips.

26. The energy storage device of claim 25, wherein the energy storage device is an electric double layer capacitor that has a specific energy of at least about 8 Wh/kg.

27. The energy storage device of claim 25, wherein the energy storage device is an electric double layer capacitor that has a specific energy of at least about 20 Wh/kg.

28. The energy storage device of claim 25, wherein the energy storage device is an electric double layer capacitor that has a specific power of at least about 50 kW/kg.

29. The energy storage device of claim 25, wherein the energy storage device is an electric double layer capacitor that has a specific power of at least about 60 kW/kg.

30. The energy storage device of claim 25, wherein the energy storage device is an electric double layer capacitor that is configured for energy storage in a hybrid-electric engine.

31. The energy storage device of claim 25, wherein the energy storage device is an electric double layer capacitor that is configured to augment peak power of a battery in a circuit.

32. A method for storing energy, the method comprising applying a potential between first energy chip and second energy chip, wherein the first energy chip and/or the second energy chip comprise a conductive material, wherein the conductive material is monolithic and comprises an open network of pores having an average pore diameter between about 0.3 nm and about 30 nm, and the conductive material forms a thin chip having a thickness of about 300 microns or less, and wherein the thickness across different portions of the chip varies by less than 10% of the thickness.

33. An energy storage system comprising multiple interconnected cells, each cell comprising two energy chips configured to be oppositely charged and an electrolyte disposed between the two energy chips, wherein at least one of the energy chips comprises a conductive material, wherein the conductive material is monolithic and comprises an open network of pores having an average pore diameter between about 0.3 nm and about 30 nm, and the conductive material forms a thin chip having a thickness of about 300 microns or less, and wherein the thickness across different portions of the chip varies by less than 10% of the thickness.

34. The energy storage system of claim 33, wherein at least some of the multiple cells are connected in series.

35. The energy storage system of claim 33, wherein at least some of the multiple cells are connected in parallel.

36. The energy storage system of claim 33, further comprising a separator disposed between the two energy chips.

37. An asymmetric ultracapacitor comprising a first energy chip configured to store charge electrostatically, and a second energy chip configured to store charge via a reversible faradaic process, wherein the first energy chip comprises a conductive material, wherein the conductive material is monolithic and comprises an open network of pores having an average pore diameter between about 0.3 nm and about 30 nm, and the conductive material forms a thin chip having a thickness of about 300 microns or less, and wherein the thickness across different portions of the chip varies by less than 10% of the thickness.

38. The asymmetric ultracapacitor of claim 37, wherein the first energy chip is configured to be positively charged.

39. The asymmetric ultracapacitor of claim 37, wherein the second energy chip comprises a conductive material, wherein the conductive material is monolithic and comprises an open network of pores having an average pore diameter between about 0.3 nm and about 30 nm, and the conductive material forms a thin chip having a thickness of about 300 microns or less, wherein the thickness across different portions of the chip varies by less than 10% of the thickness, and wherein the conductive material is selected from the group consisting of ruthenium oxide, molybdenum oxide, molybdenum nitride, molybdenum sulfide, tungsten oxide, tungsten nitride, tungsten sulfide, manganese dioxide, iron sulfide, silver oxide, nickel oxyhydroxide, and combinations thereof, and poly(3-methylthiophene).
